(19) United States
(12) Patent Application Publication
(10) Pub. No.: US 2013/0032640 A1
(43) Pub. Date: Feb. 7, 2013

(54) TARGET SUPPLY UNIT, MECHANISM FOR CLEANING NOZZLE THEREOF, AND METHOD FOR CLEANING THE NOZZLE

(71) Applicants: Takayuki YABU, Hiratsuka-shi (JP); Takeshi Kodama, Hiratsuka-shi (JP); Osamu Wakabayashi, Hiratsuka-shi (JP); Junichi Fujimoto, Hiratsuka-shi (JP)

(72) Inventors: Takayuki YABU, Hiratsuka-shi (JP); Takeshi Kodama, Hiratsuka-shi (JP); Osamu Wakabayashi, Hiratsuka-shi (JP); Junichi Fujimoto, Hiratsuka-shi (JP)

(73) Assignee: GIGAPHOTON INC.

(21) Appl. No.: 13/483,934

(22) Filed: May 30, 2012

(30) Foreign Application Priority Data
Aug. 3, 2011 (JP) 2011-170541

(51) Int. Cl. B05B 15/02; B05B 17/04

(52) U.S. Cl. 239/13; 239/114

(57) ABSTRACT

An apparatus for physically cleaning a nozzle inside a chamber may include a cleaning member disposed inside the chamber. The nozzle is configured to output a target material into the chamber in which extreme ultraviolet light is generated. The cleaning member is configured to remove the target material deposited around the nozzle.

### CROSS-REFERENCE TO RELATED APPLICATION

The present application claims priority from Japanese Patent Application No. 2011-170541 filed Aug. 3, 2011.

### BACKGROUND

1. Technical Field

This disclosure relates to a target supply unit, a mechanism for cleaning a nozzle of the target supply unit, and a method for cleaning the nozzle.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed in which a system for generating Extreme Ultraviolet (EUV) light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used.

### SUMMARY

According to one aspect of this disclosure, an apparatus for physically cleaning a nozzle inside a chamber may include a cleaning member disposed inside the chamber. The nozzle is configured to output a target material into the chamber in which extreme ultraviolet light is generated. The cleaning member is configured to remove the target material deposited around the nozzle.

A target supply unit according to another aspect of this disclosure may include: a nozzle through which a target material is outputted into a chamber in which extreme ultraviolet light is generated; the apparatus for physically cleaning the nozzle inside the chamber; and an integrator for integrating the nozzle and the apparatus.

A method according to yet another aspect of this disclosure for physically cleaning a nozzle inside a chamber, the nozzle being configured to output a target material into the chamber in which extreme ultraviolet light is generated may include physically cleaning the nozzle in the chamber that is retained at a pressure lower than the atmospheric pressure.

### BRIEF DESCRIPTION OF THE DRAWINGS

Hereinafter, selected embodiments of this disclosure will be described with reference to the accompanying drawings.

FIG. 1 schematically illustrates the configuration of an exemplary LPP type EUV light generation system.

FIG. 2 schematically illustrates an example of the configuration of an EUV light generation system to which a cleaning mechanism according to some of the embodiments of this disclosure is applied.

FIG. 3A schematically shows a state where the contact angle between a liquid and a solid is smaller than 90 degrees.

FIG. 3B schematically shows a state where the contact angle between a liquid and a solid is larger than 90 degrees.

FIG. 4 schematically illustrates an example of the configuration of a target supply unit according to a first embodiment.

FIG. 5 is a flowchart showing the operation at the time of cleaning according to the first embodiment.

FIG. 6A shows a state where a cleaning member does not face a nozzle according to the first embodiment.

FIG. 6B shows a state where the cleaning member faces the nozzle with a predetermined gap therebetween according to the first embodiment.

FIG. 6C shows a state where the cleaning member is in contact with the nozzle according to the first embodiment.

FIG. 6D shows a state where the cleaning member faces the nozzle with a predetermined gap therebetween after the cleaning is completed according to the first embodiment.

FIG. 7 schematically illustrates an example of the configuration of a target supply unit according to a second embodiment.

FIG. 8 is a flowchart showing the operation at the time of cleaning according to the second embodiment.

FIG. 9A shows a state where a cleaning member does not face a nozzle according to the second embodiment.

FIG. 9B shows a state where the cleaning member faces the nozzle with a predetermined gap therebetween according to the second embodiment.

FIG. 9C shows a state where the cleaning member is in close proximity of the nozzle according to the second embodiment.

FIG. 9D shows a state where a predetermined amount of a target material is outputted through the nozzle according to the second embodiment.

FIG. 9E shows a state where the cleaning member faces the nozzle with a predetermined gap therebetween after the cleaning is completed according to the second embodiment.

FIG. 10 is a flowchart showing the operation at the time of cleaning according to a modification of the second embodiment.

FIG. 11A shows a state where a cleaning member does not face a nozzle according to the modification of the second embodiment.

FIG. 11B shows a state where the cleaning member faces the nozzle with a predetermined gap therebetween according to the modification of the second embodiment.

FIG. 11C shows a state where a predetermined amount of a target material is outputted through the nozzle according to the modification of the second embodiment.

FIG. 11D shows a state where the cleaning member is in close proximity of the nozzle according to the modification of the second embodiment.

FIG. 11E shows a state where the cleaning member faces the nozzle with a predetermined gap therebetween after the cleaning is completed according to the modification of the second embodiment.

FIG. 12 schematically illustrates an example of the configuration of a target supply unit according to a third embodiment.

FIG. 13 is a flowchart showing the operation at the time of cleaning according to the third embodiment.

FIG. 14A shows a state where a container does not face a nozzle according to the third embodiment.

FIG. 14B shows a state where the container faces the nozzle with a predetermined gap therebetween according to the third embodiment.

FIG. 14C shows a state where a cleaning material in the container is in contact with the nozzle according to the third embodiment.

FIG. 14D shows a state where the container faces the nozzle with a predetermined gap therebetween after the cleaning is completed according to the third embodiment.

FIG. 15 schematically illustrates an example of the configuration of a target supply unit according to a fourth embodiment.

FIG. 16 is an enlarged view showing the primary components of the target supply unit according to the fourth embodiment.

FIG. 17 is a flowchart showing the operation at the time of cleaning according to the fourth embodiment.

FIG. 18A shows a state where a cleaning member does not face a nozzle according to the fourth embodiment.

FIG. 18B shows a state where the cleaning member faces the nozzle with a predetermined gap therebetween according to the fourth embodiment.

FIG. 18C shows a state where the cleaning member is in contact with the nozzle according to the fourth embodiment.

FIG. 18D shows a state where the cleaning member faces the nozzle with a predetermined gap therebetween after the cleaning is completed according to the fourth embodiment.

FIG. 19 schematically illustrates an example of the configuration of a target supply unit according to a fifth embodiment.

FIG. 20 schematically illustrates an example of the configuration of a target supply unit configured to generate droplets on-demand.

FIG. 21 schematically illustrates an example of the configuration of a target supply unit configured to generate droplets from a continuous jet.

### DESCRIPTION OF PREFERRED EMBODIMENTS

Hereinafter, selected embodiments of this disclosure will be described in detail with reference to the accompanying drawings. The embodiments to be described below are merely illustrative in nature and do not limit the scope of this disclosure. Further, configurations and operations described in each embodiment are not all essential in implementing this disclosure. Note that like elements are referenced by like reference numerals and characters, and duplicate descriptions thereof will be omitted herein.

### Contents

### 1. Overview

### 2. Overview of EUV Light Generation System

### 2.1 Configuration

### 2.2 Operation

### 3. EUV Light Generation Apparatus Including Cleaning Mechanism

### 3.1 Configuration

### 3.2 Operation

### 3.2.1 EUV Light Generation

### 3.2.2 Cleaning Operation

### 3.2.3 Effects

### 4. Contact Angle Between Liquid Metal and Solid Metal

### 5. Embodiments of EUV Light Generation Apparatus

### 5.1 First Embodiment

### 5.1.1 Configuration

### 5.1.2 Operation

### 5.2 Second Embodiment

### 5.2.1 Configuration

### 5.2.2 Operation

### 5.2.3 Modification

### 5.3 Third Embodiment

### 5.3.1 Configuration

### 5.3.2 Operation

### 5.4 Fourth Embodiment

### 5.4.1 Configuration

### 5.4.2 Operation

### 5.5 Fifth Embodiment

### 5.6 Variation of Target Supply Unit

### 5.6.1 Configuration

### 5.6.2 Operation

### 1. Overview

In selected embodiments of this disclosure, a mechanism may be provided for physically cleaning a nozzle inside a chamber in which EUV light is to be generated. When a target material is deposited around a nozzle opening, a target material to be newly outputted through the nozzle opening may come into contact with the target material deposited around the nozzle opening. Due to this contact, the direction into which the target material is outputted through the nozzle may be deflected.

According to the aforementioned cleaning mechanism, the periphery of the nozzle opening may be physically cleaned inside the chamber that is retained at a pressure lower than the atmospheric pressure. Thus, a target material to be outputted through the nozzle opening may be prevented from coming into contact with the target material deposited around the nozzle opening. Thus, the target output direction may be prevented from being deflected. Further, since the nozzle may be cleaned without opening the chamber, foreign objects may be prevented from entering the chamber. Furthermore, the target material inside the chamber may be prevented from being released to the outside of the chamber.

### 2. Overview of EUV Light Generation System

### 2.1 Configuration

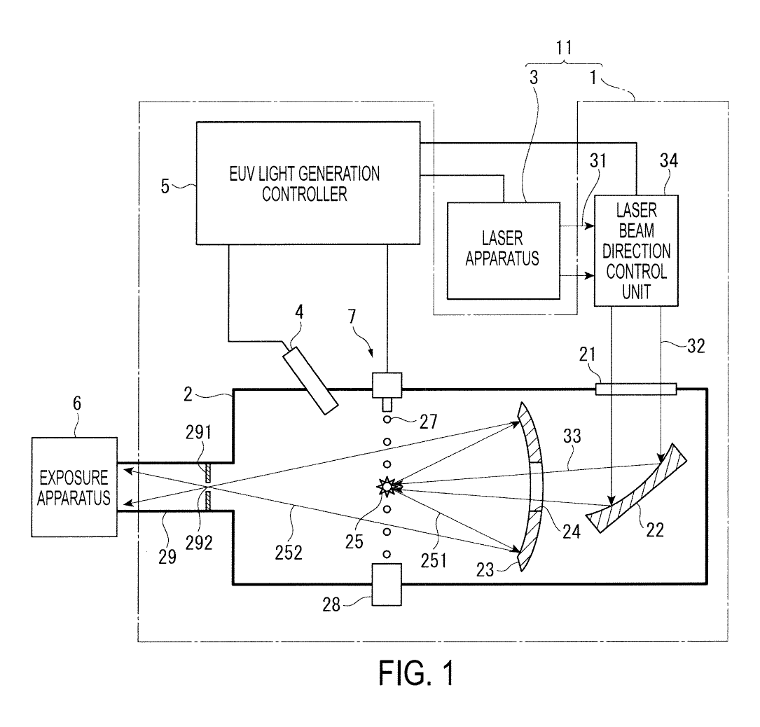

FIG. 1 schematically illustrates the configuration of an exemplary Laser Produced Plasma (LPP) type EUV light generation system. An EUV light generation apparatus 1 may be used with at least one laser apparatus 3. Hereinafter, a system that includes the EUV light generation apparatus 1 and the laser apparatus 3 may be referred to as an EUV light generation system 11. As illustrated in FIG. 1 and described in detail below, the EUV light generation system 11 may include a chamber 2, a target supply unit 7, and so forth. The chamber 2 may be airtightly sealed. The target supply unit 7 may be mounted to the chamber 2 so as to penetrate a wall of the chamber 2. A target material to be supplied by the target supply unit 7 may include, but is not limited to, tin, terbium, gadolinium, lithium, xenon, or any combination thereof.

The chamber 2 may have at least one through-hole formed in its wall, and a pulse laser beam 32 may travel through the through-hole into the chamber 2. Alternatively, the chamber 2 may be provided with a window 21, through which the pulse laser beam 32 may travel into the chamber 2. An EUV collector mirror 23 having a spheroidal surface may be provided inside the chamber 2, for example. The EUV collector mirror 23 may have a multi-layered reflective film formed on the spheroidal surface thereof. The reflective film may include a molybdenum layer and a silicon layer being laminated alternately. The EUV collector mirror 23 may have a first focus and a second focus, and preferably be positioned such that the first focus lies in a plasma generation region 25 and the second focus lies in an intermediate focus (IF) region 292 defined by the specification of an external apparatus, such as an exposure apparatus 6. The EUV collector mirror 23 may have a through-hole 24 formed at the center thereof, and a pulse laser beam 33 may travel through the through-hole 24 toward the plasma generation region 25.

The EUV light generation system 11 may further include an EUV light generation controller 5 and a target sensor 4. The target sensor 4 may have an imaging function and detect at least one of the presence, the trajectory, and the position of a target 27.

Further, the EUV light generation system 11 may include a connection part 29 that allows the interior of the chamber 2 and the interior of the exposure apparatus 6 to be in communication with each other. A wall 291 having an aperture may be provided inside the connection part 29, and the wall 291 may be positioned such that the second focus of the EUV collector mirror 23 lies in the aperture formed in the wall 291.

The EUV light generation system 11 may also include a laser beam direction control unit 34, a laser beam focusing mirror 22, and a target collector 28 for collecting targets 27. The laser beam direction control unit 34 may include an optical element (not separately shown) for defining the direction into which the pulse laser beam 32 travels and an actuator (not separately shown) for adjusting the position and the orientation (posture) of the optical element.

### 2.2 Operation

With continued reference to FIG. 1, a pulse laser beam 31 outputted from the laser apparatus 3 may pass through the laser beam direction control unit 34 and be outputted therefrom as a pulse laser beam 32 after having its direction optionally adjusted. The pulse laser beam 32 may travel through the window 21 and enter the chamber 2. The pulse laser beam 32 may travel inside the chamber 2 along at least one beam path, be reflected by the laser beam focusing mirror 22, and strike at least one target 27 as a pulse laser beam 33.

The target supply unit 7 may be configured to output the target(s) 27 toward the plasma generation region 25 inside the chamber 2. The target 27 may be irradiated with at least one pulse of the pulse laser beam 33. Upon being irradiated with the pulse laser beam 33, the target 27 may be turned into plasma, and rays of light including EUV light 251 may be emitted from the plasma. The EUV light 251 may be reflected selectively by the EUV collector mirror 23. EUV light 252 reflected by the EUV collector mirror 23 may travel through the intermediate focus region 292 and be outputted to the exposure apparatus 6. The target 27 may be irradiated with multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control at least one of the timing at which the target 27 is outputted and the direction into which the target 27 is outputted (e.g., the timing at which and/or direction in which the target 27 is outputted from target supply unit 7). Furthermore, the EUV light generation controller 5 may be configured to control at least one of the timing at which the laser apparatus 3 oscillates (e.g., by controlling the laser apparatus 3), the direction in which the pulse laser beam 32 travels (e.g., by controlling the laser beam direction control unit 34), and the position at which the pulse laser beam 33 is focused (e.g., by controlling the laser apparatus 3, the laser beam direction control unit 34, or the like). It will be appreciated that the various controls mentioned above are merely examples, and other controls may be added as necessary.

### 3. EUV Light Generation Apparatus Including Cleaning Mechanism

### 3.1 Configuration

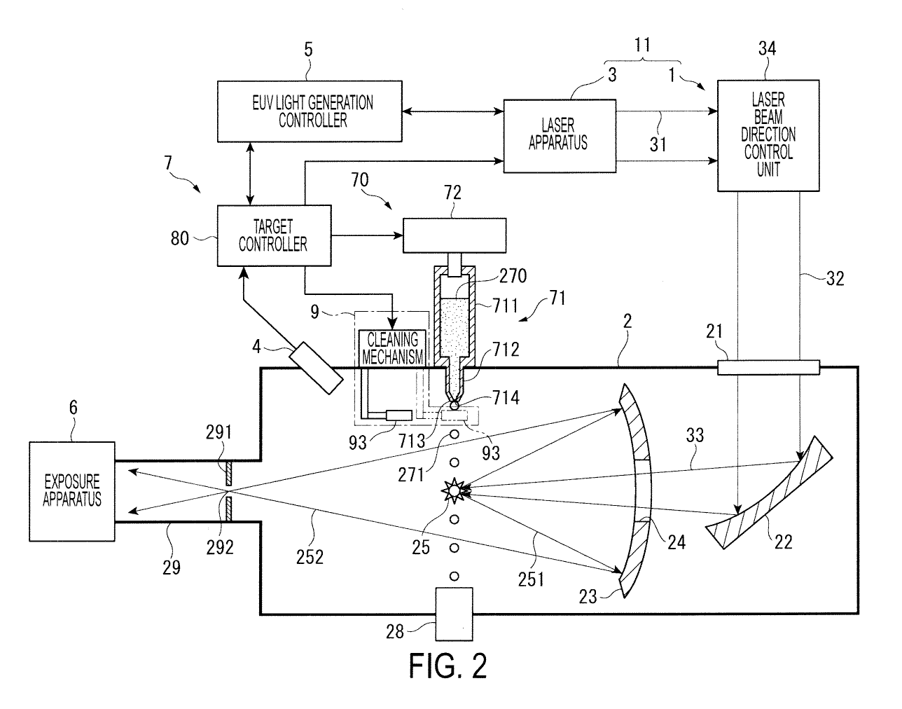

FIG. 2 schematically illustrates an example of the configuration of an EUV light generation system to which a cleaning mechanism according to some of the embodiments of this disclosure is applied. An EUV light generation apparatus 1 may include a chamber 2, a target supply unit 7, and a cleaning mechanism 9. The target supply unit 7 may include a target generation unit 70 and a target controller 80.

The target generation unit 70 may include a target generator 71 and a pressure adjuster 72. The target generator 71 may include a tank 711 for storing a target material 270 thereinside. The tank 711 may be cylindrical in shape. The tank 711 may include a nozzle 712, and the target material 270 stored inside the tank 711 may be outputted through the nozzle 712 into the chamber 2 as a target 271. A nozzle opening 714 may be formed at a tip 713 of the nozzle 712. The target generator 71 may be mounted onto the chamber 2 such that the tank 711 is located outside the chamber 2 and the nozzle 712 is located inside the chamber 2. The pressure adjuster 72 may be connected to the tank 711.

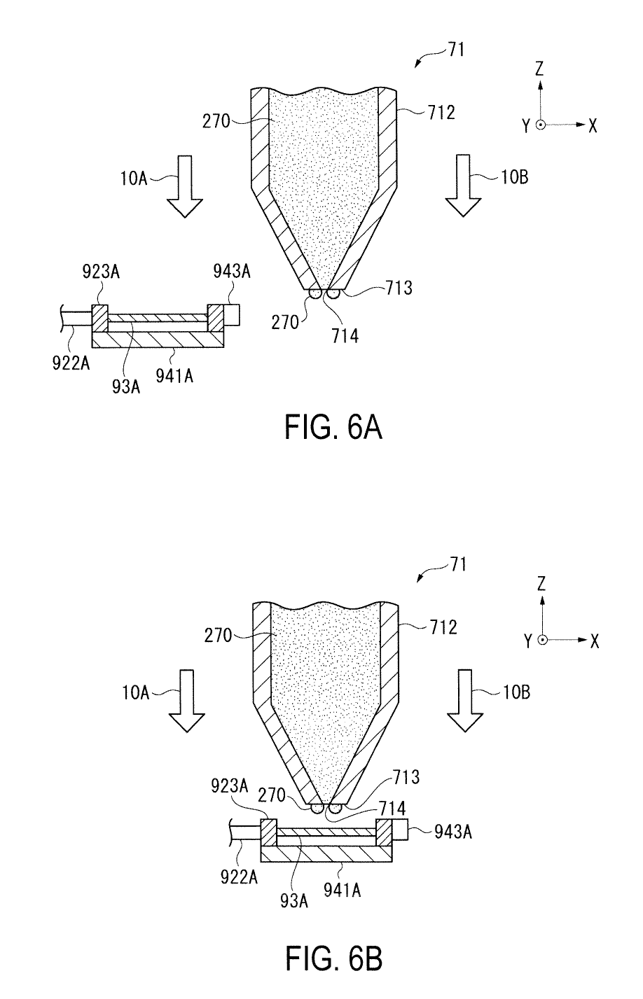

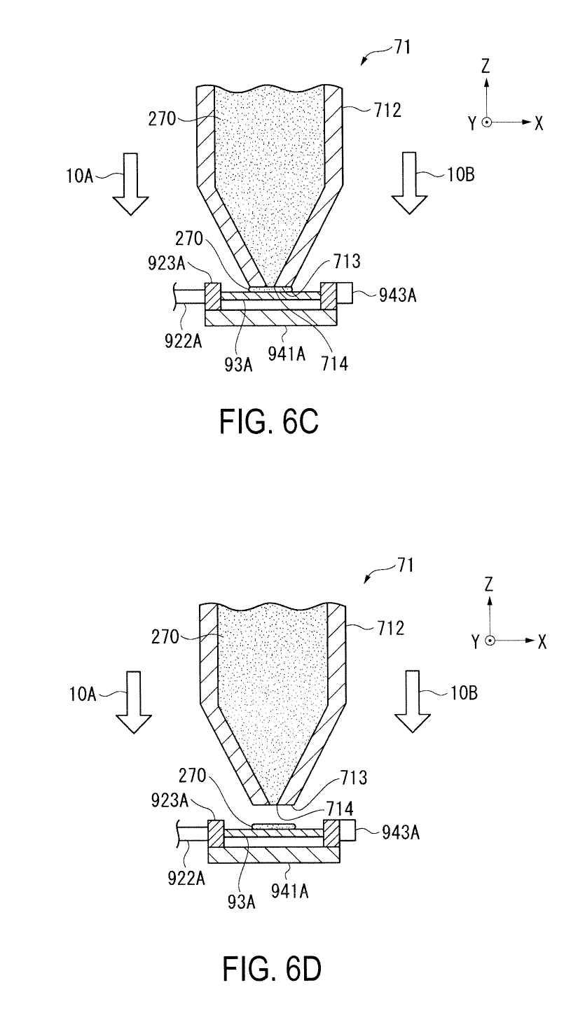

Depending on the installation mode of the chamber 2, a set output direction 10A of the target 271 (see FIG. 6A) may not necessarily coincide with the gravitational direction 10B (see FIG. 6A). The target 271 may be outputted in a direction inclined with respect to the gravitational direction 10B or in the horizontal direction.

The target controller 80 may be configured to control the target generation unit 70 and the cleaning mechanism 9.

The cleaning mechanism 9 may be configured to clean the nozzle 712 by removing the target material 270 deposited around the nozzle opening 714 of the nozzle 712. The cleaning mechanism 9 may position a cleaning member 93 in contact with or in close proximity of the nozzle 712 to clean the nozzle 712. The cleaning mechanism 9 may drive the cleaning member 93 while retaining the pressure inside the chamber 2, that is, while keeping the chamber 2 airtightly closed.

### 3.2 Operation

### 3.2.1 EUV Light Generation

Referring to FIG. 2, the operation of the target supply unit 7 will now be discussed. Upon receiving a target generation signal from an EUV light generation controller 5, the target controller 80 may send a signal to the pressure adjuster 72 to adjust the pressure inside the tank 711. Upon receiving the signal, the pressure adjuster 72 may adjust the pressure inside the tank 711 to a pressure at which the target 271 is outputted.

With this adjusted pressure, the target 271 may be outputted through the nozzle 712 of the target generator 71. Information indicating the position, the speed, the size, the travel direction, and so forth of the target 271 may be detected by a target sensor 4. The detected information may then be sent to the EUV light generation controller 5 via the target controller 80. Based on the received information, the EUV light generation controller 5 may input an oscillation trigger for the pulse laser beam 31 to the laser apparatus 3 such that the target 271 is irradiated with the pulse laser beam 33 in the plasma generation region 25. Having been irradiated with the pulse laser beam 33, the target 271 may be turned into plasma, and rays of light including the EUV light 251 may be emitted from the plasma.

### 3.2.2 Cleaning Operation

Referring to FIG. 2, method for cleaning the nozzle 712 may include physically cleaning the nozzle 712 inside the chamber 2 that is retained at a pressure lower than the atmospheric pressure. Here, the state where the pressure inside the chamber 2 is lower than the atmospheric pressure means that the chamber 2 is not opened after the EUV light is generated and the pressure inside the chamber 2 is substantially the same as the pressure at the time of generating the EUV light.

The nozzle 712 may be cleaned at any of the following timings.

Timing 1: When the generation of the EUV light is paused for more than a predetermined time after the EUV light is generated for another predetermined time in the EUV light generation apparatus.
Timing 2: When the duration for which the target material is outputted exceeds a predetermined time, or in the case where the target material is outputted in the form of droplets, when the number of outputted droplets exceeds a predetermined value.
Timing 3: When the positional stability of the target material is deteriorated, or when the positional deviation of the target material falls out of a predetermined range.

The EUV light generation controller 5 may be configured to monitor and manage the above-noted timings 1, 2, and 3, and send a cleaning signal to the target controller 80 accordingly. Here, when the EUV light is to be generated, the target controller 80 may send a retraction signal to the cleaning mechanism 9 and retract the cleaning member 93 to the position shown in the solid line (see FIG. 2).

At a timing at which the cleaning is to be carried out, the target controller 80 may send a cleaning signal to the cleaning mechanism 9 so that the cleaning of the nozzle 712 may be carried out. Upon receiving the cleaning signal, the cleaning mechanism 9 may move the cleaning member 93 to the position indicated in the two-dotted-dashed line (see FIG. 2) so as to position the cleaning member 93 in contact with or in close proximity of the nozzle 712. With this contact configuration, the nozzle 712 on which the target material 270 is deposited may be physically cleaned. Details of the cleaning operation will be described later.

### 3.3.3 Effects

Referring to FIG. 2, with the above-noted configuration and operation, the target material 270 to be outputted through the nozzle 712 after the cleaning may be prevented from being deflected.

Further, since the nozzle 712 may be cleaned without opening the chamber 2, foreign objects may be prevented from entering the chamber 2, or the target 271 inside the chamber 2 may be prevented from being released to the outside of the chamber 2. Furthermore, the pressure inside the chamber 2 is retained during the cleaning at the pressure at which the EUV light is generated, which may render it unnecessary to readjust the pressure inside the chamber 2 after the cleaning. Accordingly, the time required to restart the EUV light generation operation may be shortened.

### 4. Contact Angle Between Liquid Metal and Solid Metal

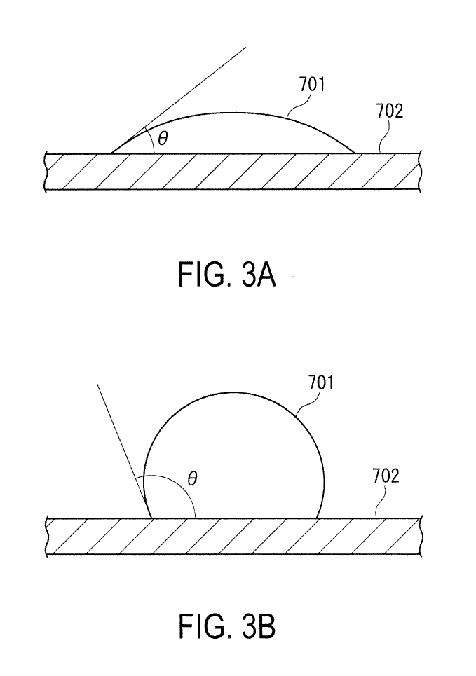

FIG. 3A schematically shows a state where the contact angle between a liquid and a solid is smaller than 90 degrees. FIG. 3B schematically shows a state where the contact angle between a liquid and a solid is larger than 90 degrees. Generally, wettability between a liquid and a solid may be evaluated in terms of the contact angle. The contact angle is an angle formed by the surface of a solid 702 and the tangent of the surface of a droplet 701 at the point where the droplet 701 makes contact with the surface of the solid 702. As shown in FIG. 3A, the case where the contact angle is in the range of 0° to 90° (inclusive) may be referred to as immersional wetting. In this case, the liquid may eventually be immersed into the solid. On the other hand, as shown in FIG. 3B, the case where the contact angle exceeds 90° may be referred to as adhesional wetting. In this case, the wetting may not progress and a droplet phase may be retained for some time.

In the case where a solid metal does not melt by coming into contact with a liquid metal, the contact angle between the liquid metal and the solid metal may be obtained through Formula (I) below. The contact angles obtained through the following formula are known to substantially match the contact angles obtained through experiments.

1−cos θ=0.36(Tx/Ty−1)−0.04 (1)

θ: contact angle

Tx: melting point of solid metal

Ty: melting point of liquid metal

### 5. Embodiments of EUV Light Generation Apparatus

### 5.1 First Embodiment

### 5.1.1 Configuration

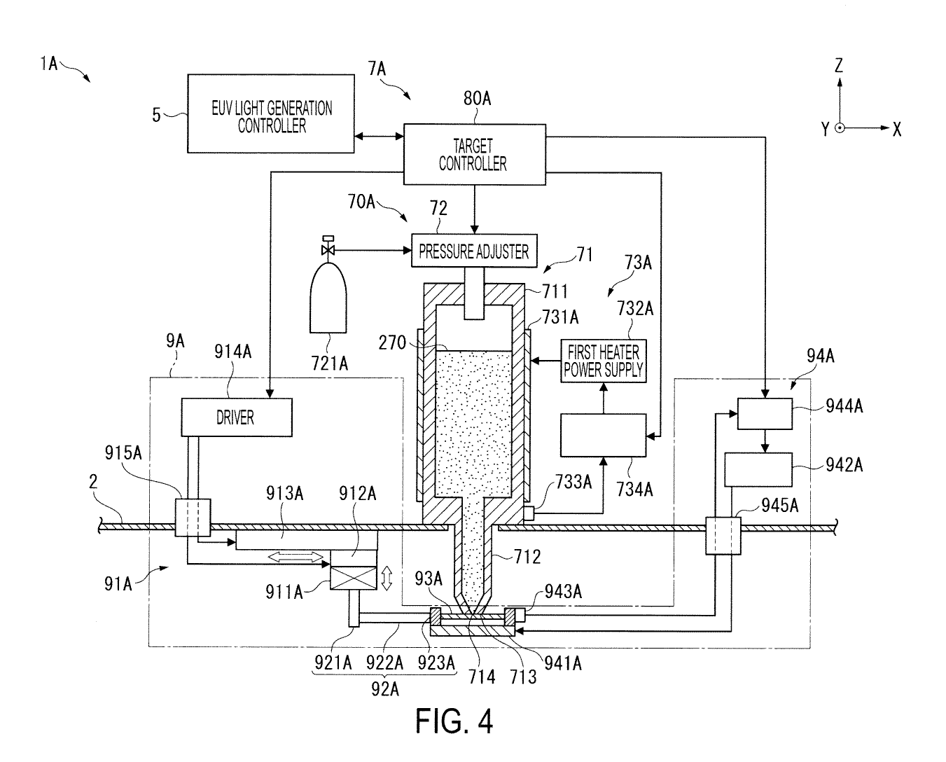

FIG. 4 schematically illustrates an example of the configuration of a part of an EUV light generation apparatus according to a first embodiment. An EUV light generation apparatus 1A may include the chamber 2, a target supply unit 7A, and a cleaning mechanism 9A. The target supply unit 7A may include a target generation unit 70A and a target controller 80A. The target generation unit 70A may include the target generator 71, the pressure adjuster 72, and a first temperature adjuster 73A.

The target material 270 stored inside the tank 711 may be a metal, such as tin, gadolinium, and terbium. The melting point of tin is 232° C., the melting point of gadolinium is 1312° C., and the melting point of terbium is 1356° C.

At least the tip 713 of the nozzle 712 may be formed of a material having low wettability with the target material 270. More specifically, the tip 713 may preferably be formed of a material having a contact angle larger than 90° with the target material 270. When the tip 713 is not formed of a material having low wettability with the target material 270, the tip 713 may preferably be coated with a material having low wettability with the target material 270 on at least the surface thereof.

An inert gas cylinder 721A may be connected to the pressure adjuster 72. The pressure adjuster 72 may be configured to control the pressure of the inert gas supplied from the inert gas cylinder 721A to thereby adjust the pressure inside the tank 711.

The first temperature adjuster 73A may be configured to control the temperature of the target material 270 inside the tank 711. The first temperature adjuster 73A may include a first heater 731A, a first heater power supply 732A, a first temperature sensor 733A, and a first temperature controller 734A. The first heater 731A may be provided on the outer surface of the tank 711. The first heater power supply 732A may be connected to the first heater 731A and the first temperature controller 734A. The first heater power supply 732A may supply power to the first heater 731A based on a signal from the first temperature controller 734A so that the target material 270 inside the tank 711 may be heated.

The first temperature sensor 733A may be provided on the outer surface of the tank 711 toward the nozzle 712. Alternatively, the first temperature sensor 733A may be provided inside the tank 711. The first temperature controller 734A may be connected to the first temperature sensor 733A. The first temperature sensor 733A may detect the temperature of the target material 270 inside the tank 711, and send a signal corresponding to the detected temperature to the first temperature controller 734A. The first temperature controller 734A may determine the temperature of the target material 270 based on the signal from the first temperature sensor 733A, and output a signal to the first heater power supply 732A to adjust the temperature of the target material 270 to a predetermined temperature.

The cleaning mechanism 9A may include a driving mechanism 91A (contact moving mechanism), a holding unit 92A, a cleaning member 93A, and a second temperature adjuster 94A (temperature adjuster). The driving mechanism 91 may move the cleaning member 93A with respect to the nozzle 712 so that the cleaning member 93A comes into contact with the nozzle 712. The driving mechanism 91A may be configured to be capable of moving the cleaning member 93A without opening the chamber 2. The driving mechanism 91A may include a stage 911A, a Z-direction driving mechanism 912A, an X-direction driving mechanism 913A, and a driver 914A.

The stage 911A, the Z-direction driving mechanism 912A, and the X-direction driving mechanism 913A may be provided inside the chamber 2. The stage 911A may be movable in the Z-direction through the Z-direction driving mechanism 912A. The Z-direction driving mechanism 912A may be movable in the X-direction through the X-direction driving mechanism 913A.

The driver 914A may be provided outside the chamber 2. The driver 914A may be connected to the Z-direction driving mechanism 912A and the X-direction driving mechanism 913A through a first introduction terminal 915A provided in the wall of the chamber 2.

The holding unit 92A may hold the cleaning member 93A inside the chamber 2. The holding unit 92A may include a pole 921A, an insulating member 922A, and a holder 923A. The pole 921A may be provided so as to extend from the bottom surface of the stage 911A in the Z-direction. The insulating member 922A may be provided so as to extend from the leading end of the pole 921A in the X-direction. The holder 923A may be formed of a material having high thermal conductivity and in a cylindrical shape. The cleaning member 93A may be held inside the holder 923A. The holder 923A may be connected to the leading end of the insulating member 922A. Here, the holder 923A may be formed in a polygonal cylinder, or need not have a bottom.

The cleaning member 93A may preferably be formed of a material having higher wettability with the target material 270 than the surface of the tip 713. The cleaning member 93A may be a metallic foil, a metallic cloth, or the like. However, the cleaning member 93A may preferably be a metallic foil since the damage to the tip 713 at the time of contact between the cleaning member 93A and the tip 713 may be reduced.

When the target material 270 is tin, the cleaning member 93A may be formed of a material listed in Table 1 below. When the target material 270 is gadolinium, the cleaning member 93A may be formed of a material listed in Table 2 below. When the target material 270 is terbium, the cleaning member 93A may be formed of a material listed in Table 3 below. Of the materials listed in Tables 1 through 3, gold, aluminum, silver, and nickel may be preferable as the material for the cleaning member 93A since they are relatively soft and less likely to rust and thus the surface condition thereof may be stable. Alternatively, the cleaning member 93A may be coated with the materials listed in Tables 1 through 3 when the cleaning member 93A is formed of a material other than those listed in Tables 1 through 3.

TABLE 1

| METAL | CONTACT ANGLE θ (°) |
|---|---|
| T1 | 8.6 |
| Cd | 12.4 |
| Pb | 13.7 |
| Zn | 25.0 |
| Te | 28.0 |
| Sb | 40.9 |
| Mg | 42.2 |
| Al | 42.7 |
| Ba | 46.0 |
| Sr | 49.0 |
| Ce | 49.8 |
| Ca | 51.1 |
| La | 55.0 |
| Ge | 58.5 |
| Ag | 58.6 |
| Au | 63.4 |
| Cu | 64.3 |
| U | 66.5 |
| Mn | 71.4 |
| Be | 73.1 |
| Sc | 77.9 |
| Si | 78.4 |
| Ni | 80.3 |
| Y | 81.2 |
| Co | 81.3 |
| Fe | 83.8 |
| Pd | 84.4 |

TABLE 2

| METAL | CONTACT ANGLE θ (°) |
|---|---|
| Fe | 8.7 |
| Pd | 10.0 |
| V | 17.7 |
| Ti | 19.0 |
| Pt | 20.8 |
| Th | 22.6 |
| Cr | 25.0 |
| Rh | 27.0 |
| Zr | 31.3 |
| Ru | 38.1 |
| Ir | 38.7 |
| Nb | 39.6 |
| Mo | 42.1 |
| Os | 43.5 |
| Ta | 48.9 |
| W | 55.3 |

TABLE 3

| METAL | CONTACT ANGLE θ (°) |
|---|---|
| Pt | 6.4 |
| Th | 10.5 |
| Cr | 14.4 |
| Rh | 17.2 |
| Zr | 22.5 |
| Ru | 30.2 |
| Ir | 30.8 |
| Nb | 31.8 |
| Mo | 34.4 |
| Os | 35.8 |
| Ta | 41.3 |
| W | 47.6 |

The second temperature adjuster 94A may be configured to control the temperature of the cleaning member 93A. The second temperature adjuster 94A may include a second heater 941A, a second heater power supply 942A, a second temperature sensor 943A, and a second temperature controller 944A. The second heater 941A may be provided on the holder 923A at a side opposite to the side facing the nozzle 712. The second heater 941A may be a thin ceramic heater. For example, the second heater 941A may be a ceramic heater manufactured through a vacuum pyrolysis CVD method, in which pyrolytic boron nitride and pyrolytic graphite are laminated in layers. The second heater power supply 942A may be connected to the second heater 941A through a second introduction terminal 945A provided in the wall of the chamber 2. The second heater power supply 942A may be connected to the second temperature controller 944A. The second heater power supply 942A may supply power to the second heater 941A based on a signal from the second temperature controller 944A. Thus, the cleaning member 93A may be heated from the bottom surface thereof by radiant heat. Alternatively, the cleaning member 93A may be indirectly heated through conducted heat from the second heater 941A through the holder 923A.

The second temperature sensor 943A may be provided on the outer surface of the holder 923A. The second temperature sensor 943A may be connected to the second temperature controller 944A through the second introduction terminal 945A. The second temperature sensor 943A may be configured to detect the temperature of the cleaning member 93A, and send a signal corresponding to the detected temperature to the second temperature controller 944A. The second temperature controller 944A may determine the temperature of the cleaning member 93A based on the signal from the second temperature sensor 943A, and output a signal to the second heater power supply 942A to adjust the temperature of the cleaning member 93A to a predetermined temperature.

The target controller 80A may be connected to the EUV light generation controller 5, the pressure adjuster 72, the first temperature controller 734A, the driver 914A, and the second temperature controller 944A.

### 5.1.2 Operation

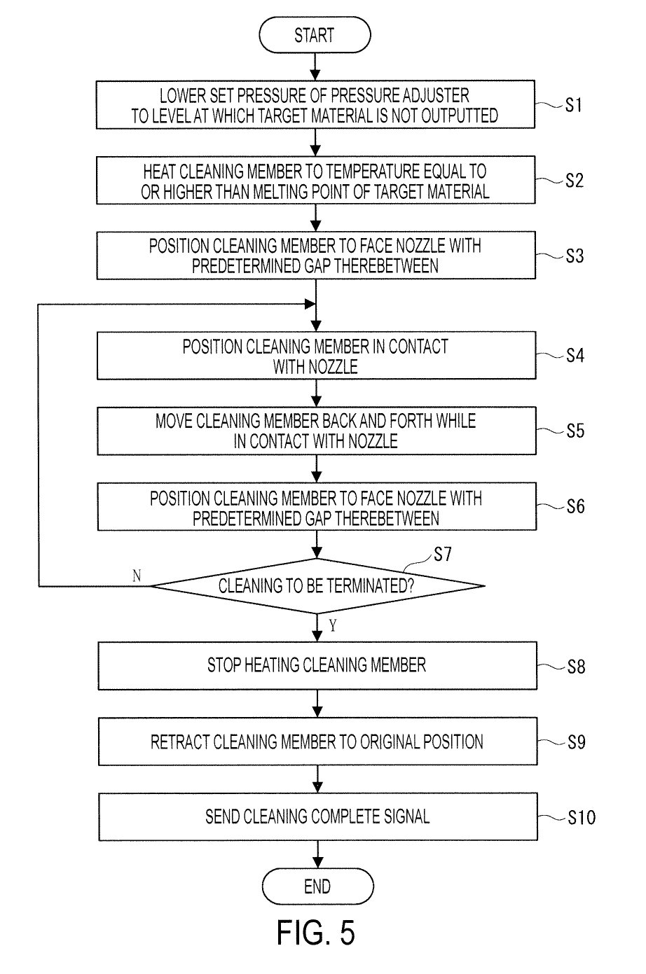

FIG. 5 is a flowchart showing the operation at the time of cleaning according to the first embodiment. FIG. 6A shows a state where the cleaning member does not face the nozzle according to the first embodiment. FIG. 6B shows a state where the cleaning member faces the nozzle with a predetermined gap therebetween according to the first embodiment. FIG. 6C shows a state where the cleaning member is in contact with the nozzle according to the first embodiment. FIG. 6D shows a state where the cleaning member faces the nozzle with a predetermined gap therebetween after the cleaning is completed according to the first embodiment.

When the target controller 80A receives a cleaning signal from the EUV light generation controller 5, the target controller 80A may send a signal to the pressure adjuster 72 to lower the set pressure of the pressure adjuster 72 to a level at which the target material 270 is not outputted (Step S1). Then, the target controller 80A may send a signal to the second temperature controller 944A so that the cleaning member 93A is heated to a temperature equal to or higher than the melting point of the target material 270 (Step S2). Upon receiving this signal, the second temperature controller 944A may control the power to be supplied to the second heater 941A in consideration of a detection result of the second temperature sensor 943A. Thus, the temperature of the cleaning member 93A may be adjusted to a predetermined temperature. In Steps S1 and S2, the cleaning member 93A may be positioned not to face the nozzle 712, as shown in FIG. 6A.

Based on the detection result of the second temperature sensor 943A, the second temperature controller 944A may send a signal to the target controller 80A indicating that the temperature of the cleaning member 93A has reached or exceeded the melting point of the target material 270. Upon receiving the signal, the target controller 80A may send a signal to the driver 914A so that the driver 914A may move the holding unit 92A in the X-direction through the X-direction driving mechanism 913A so that the cleaning member 93A faces the tip 713 (Step S3). As a result, the cleaning member 93A may face the tip 713 with a predetermined gap therebetween, as shown in FIG. 6B.

Then, the target controller 80A may send a signal to the driver 914A so that the driver 914A may move the holding unit 92A in the Z-direction through the Z-direction driving mechanism 912A so that the cleaning member 93A comes into contact with the tip 713 (Step S4). As a result, the cleaning member 93A may be in contact with the tip 713, as shown in FIG. 6C.

As the cleaning member 93A makes contact with the tip 713, the target material 270 deposited around the nozzle opening 714 may adhere onto the cleaning member 93A. When the cleaning member 93A is formed of a material having higher wettability with the target material 270 than the tip 713, most of the target material 270 deposited around the nozzle opening 714 may adhere onto the cleaning member 93A.

Thereafter, the target controller 80A may control the X-direction driving mechanism 913A through the driver 914A so that the cleaning member 93A is moved back and forth in the X-direction while the cleaning member 93A is in contact with the tip 713 (Step S5). Here, the cleaning member 93A may be moved only in one direction.

Then, the target controller 80A may control the Z-direction driving mechanism 912A through the driver 914A to thereby move the holding unit 92A in the Z-direction away from the nozzle (Step S6). Thus, the cleaning member 93A may face the tip 713 with a predetermined gap therebetween, as shown in FIG. 6D. The distance between the cleaning member 93A and the tip 713 at this point may be the same as or different from that in the state shown in FIG. 6B.

In this way, by removing the cleaning member 93A away from the tip 713, most of the target material 270 deposited on the tip 713 may adhere onto the cleaning member 93A. Thus, the target material 270 may be removed from the tip 713.

Thereafter, the target controller 80A may determine whether or not to terminate the cleaning (Step S7). When the target controller 80A determines not to terminate the cleaning (Step S7; NO), the target controller 80A may return to Step S4.

On the other hand, when the target controller 80A determines to terminate the cleaning (Step S7; YES), the target controller 80A may send a signal to the second temperature controller 944A to thereby stop the heating of the cleaning member 93A (Step S8). Upon receiving this signal, the second temperature controller 944A may control the second heater power supply 942A to thereby stop the power from being supplied to the second heater 941A. Thus, the heating of the cleaning member 93A may be stopped.

Thereafter, the target controller 80A may control the X-direction driving mechanism 913A through the driver 914A so that the cleaning member 93A is retracted to the position shown, for example, in FIG. 6A (Step S9). Then, the target controller 80A may send a cleaning complete signal to the EUV light generation controller 5, whereby the cleaning may be terminated (Step S10).

With the above-noted configuration and operation, the target material 270 deposited on the nozzle 712 may be physically removed by the cleaning member 93A, whereby the nozzle 712 may be cleaned. Not only when the set output direction 10A coincides with the gravitational direction 10B (see FIGS. 6A-6D), but also when the set output direction 10A is inclined with respect to the gravitational direction 10B or perpendicular to the gravitational direction 10B, the target material 270 deposited on the nozzle 712 may adhere onto the cleaning member 93A, whereby the nozzle 712 may be cleaned.

Further, since the cleaning member 93A is moved back and forth in the X-direction while the cleaning member 93A is in contact with the nozzle 712, the contact area between the nozzle 712 and the cleaning member 93A may be increased. Thus, the amount of the target material 270 that adheres onto the cleaning member 93A may be increased.

Here, the driving mechanism 91A may be configured to move both the cleaning member 93A and the nozzle 712 or only the nozzle 712 to allow the cleaning member 93A and the nozzle 712 to make contact with each other. Further, Step S7 may be omitted, and Step 8 may be carried out after Step S6. Furthermore, Step S5 may be omitted as well.

### 5.2 Second Embodiment

### 5.2.1 Configuration

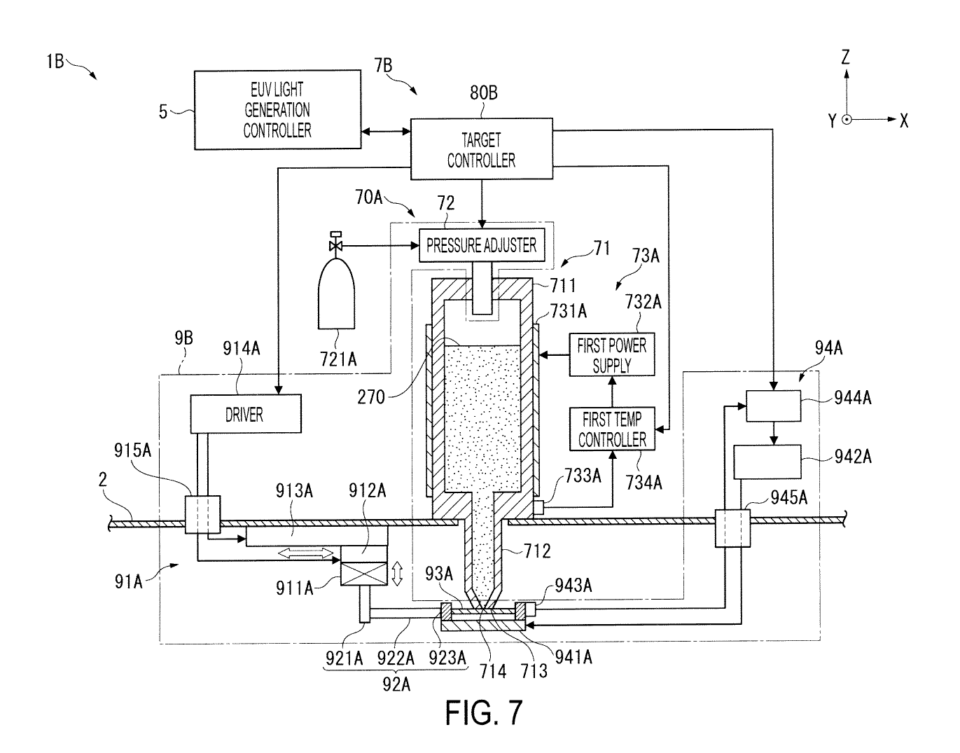

FIG. 7 schematically illustrates an example of the configuration of a part of an EUV light generation apparatus according to a second embodiment. An EUV light generation apparatus 1B may include the chamber 2, a target supply unit 7B, and a cleaning mechanism 9B. The target supply unit 7B may include the target generation unit 70A and a target controller 80B.

The cleaning mechanism 9B may include the driving mechanism 91A (close-proximity moving mechanism), the holding unit 92A, and the second temperature adjuster 94A. Further, the pressure adjuster 72 may be configured to function as an output controller constituting the cleaning mechanism 9B. The driving mechanism 91 may be configured to move the cleaning member 93A with respect to the nozzle 712 so that the cleaning member 93A comes in close proximity of the nozzle 712.

### 5.2.2 Operation

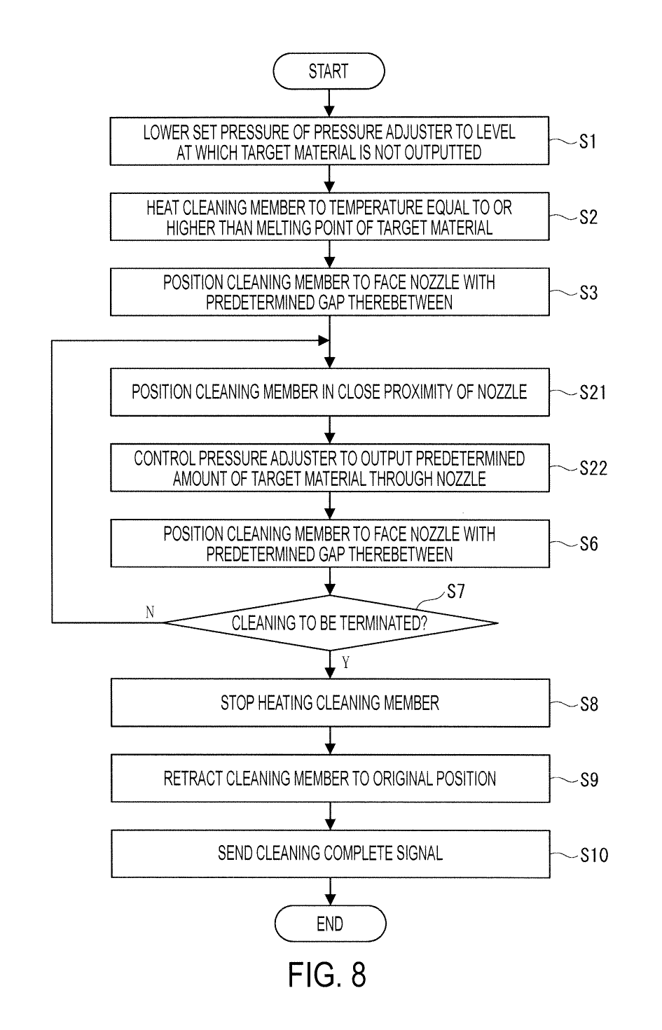

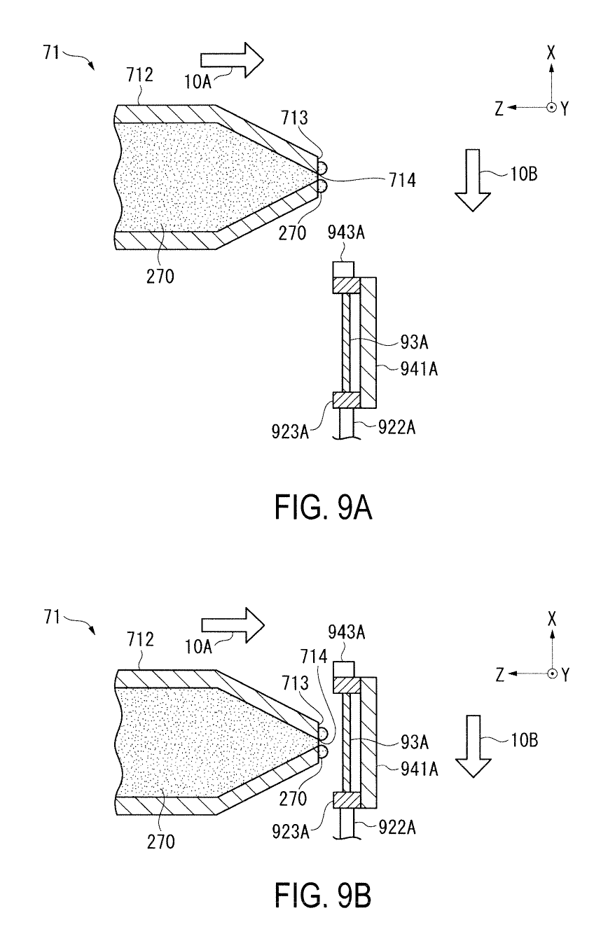

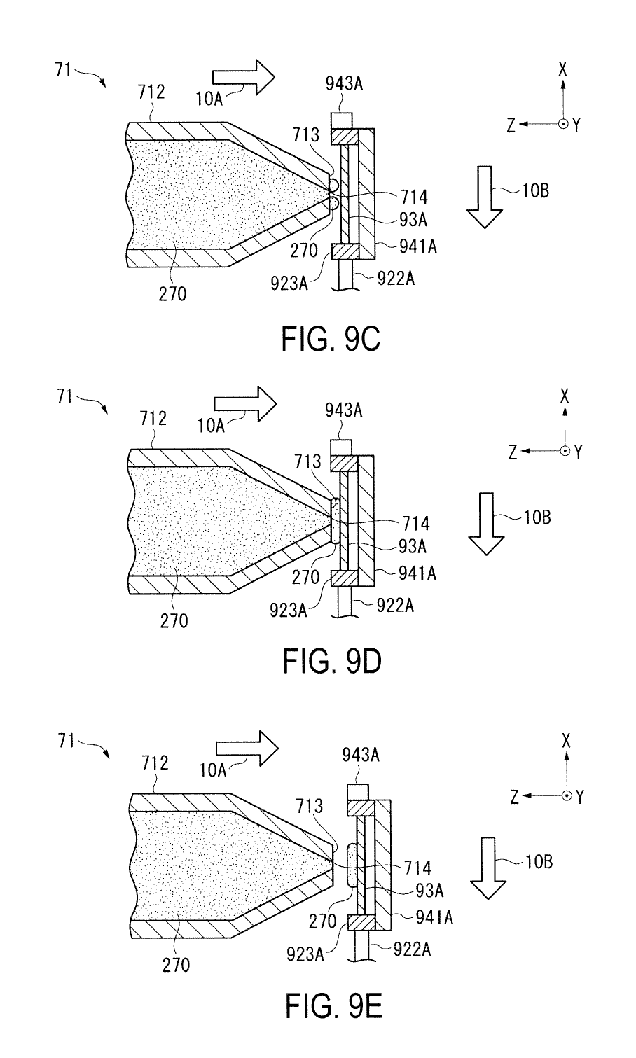

FIG. 8 is a flowchart showing the operation at the time of cleaning according to the second embodiment. FIG. 9A shows a state where the cleaning member does not face the nozzle according to the second embodiment. FIG. 9B shows a state where the cleaning member faces the nozzle with a predetermined gap therebetween according to the second embodiment. FIG. 9C shows a state where the cleaning member is in close proximity of the nozzle according to the second embodiment. FIG. 9D shows a state where a predetermined amount of the target material is outputted through the nozzle according to the second embodiment. FIG. 9E shows a state where the cleaning member faces the nozzle with a predetermined gap therebetween after the cleaning is completed according to the second embodiment.

In the second embodiment, the case where the set output direction 10A is perpendicular to the gravitational direction 10B will be illustrated.

Steps S1 and S2 of FIG. 8 may first be carried out in the EUV light generation apparatus 1B. Steps S1 and S2 may be similar to those of the first embodiment. At this time, the positional relationship between the cleaning member 93A and the nozzle 712 may be as shown in FIG. 9A. Thereafter, the target controller 80B may move the cleaning member 93A in the X-direction so that the cleaning member 93A faces the tip 713 with a predetermined gap therebetween as shown in FIG. 9B (Step S3).

Then, the target controller 80B may send a signal to the driver 914A. Thus, the driver 914A may move the holding unit 92A in the Z-direction so that the cleaning member 93A comes in close proximity of the tip 713 (Step S21). At this point, a gap between the cleaning member 93A and the tip 713 may be smaller than the predetermined gap of Step 3, as shown in FIG. 9C. Also, at this point, the target material 270 deposited around the nozzle opening 714 need not adhere onto the cleaning member 93A, as shown in FIG. 9C.

Thereafter, the target controller 80B may send a signal to the pressure adjuster 72, to thereby control the set pressure of the pressure adjuster 72 to a level at which a predetermined amount of the target material 270 is outputted through the nozzle 712 (Step S22). By causing the predetermined amount of the target material 270 to be outputted through the nozzle 712, a space between the tip 713 and the cleaning member 93A may be filled with the target material 270, as shown in FIG. 9D. Thus, the target material 270 deposited around the nozzle opening 714 (see FIG. 9C) may be taken into the target material 270 with which the space between the tip 713 and the cleaning member 93A is filled. Accordingly, the target material 270 may adhere onto the cleaning member 93A. As a result, most of the target material 270 deposited around the nozzle opening 714 may be adhered onto the cleaning member 93A which may have higher wettability with the target material 270 than the tip 713.

Then, the target controller 80B may move the holding unit 92A in the Z-direction away from the nozzle 712, as shown in FIG. 9E (Step S6). Thus, the cleaning member 93A may face the tip 713 with a predetermined gap therebetween.

In this way, by removing the cleaning member 93A away from the tip 713, most of the target material 270 deposited on the tip 713 may adhere onto the cleaning member 93A. Thus, the target material 270 may be removed from the tip 713.

Thereafter, the target controller 80B may carry out Steps S7 through S10 of FIG. 8. Steps S7 through S10 may be similar to those of the first embodiment.

With the above-noted configuration and operation, the target material 270 deposited on the nozzle 712 may be physically removed by the cleaning member 93A, whereby the nozzle 712 may be cleaned. Not only when the set output direction 10A is perpendicular to the gravitational direction 10B, but also when the set output direction 10A is inclined with respect to the gravitational direction 10B or coincides with the gravitational direction 10B, the target material 270 deposited on the nozzle 712 may adhere onto the cleaning member 93A, whereby the nozzle 712 may be cleaned. Here, the state where the space between the nozzle 712 and the cleaning member 93A is filled with the target material 270 may be retained due to the surface tension of the target material 270.

In this way, even without positioning the cleaning member 93A and the nozzle 712 in contact with each other, by positioning the cleaning member 93A in close proximity of the nozzle 712 and causing a predetermined amount of the target material 270 to be outputted through the nozzle 712, the target material 270 deposited around the nozzle opening 714 may adhere onto the cleaning member 93A and be removed from the nozzle 712. In this case, since the nozzle 712 and the cleaning member 93A do not come in contact with each other, the damage to the nozzle 712 may be suppressed.

### 5.2.3 Modification

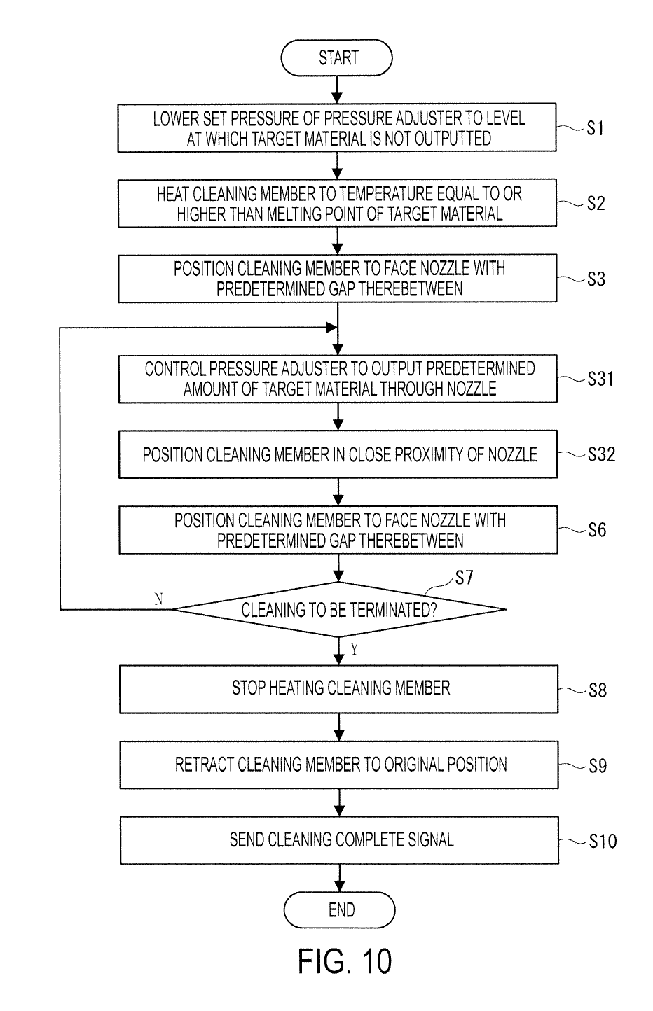

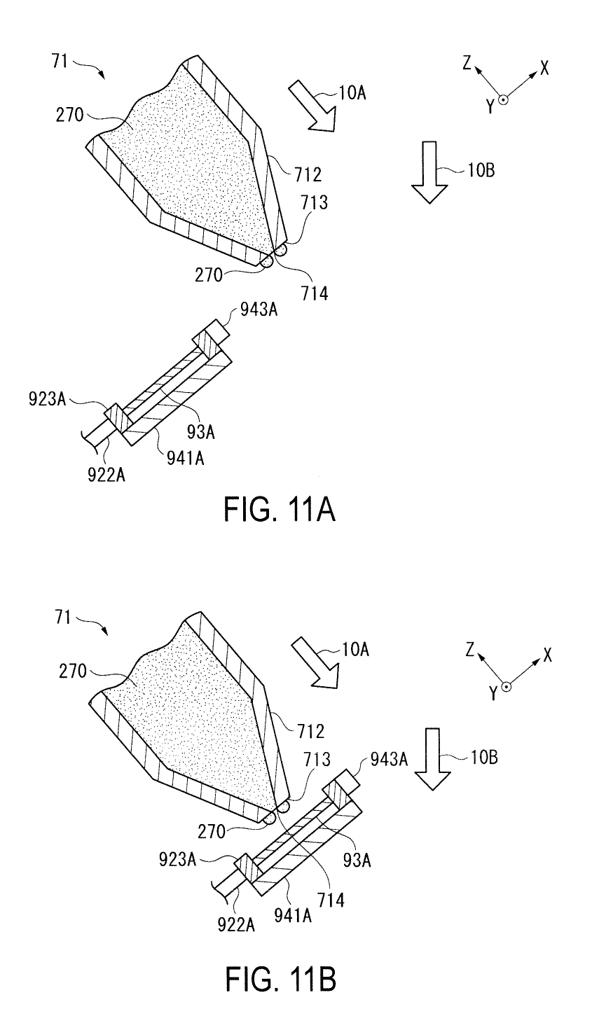

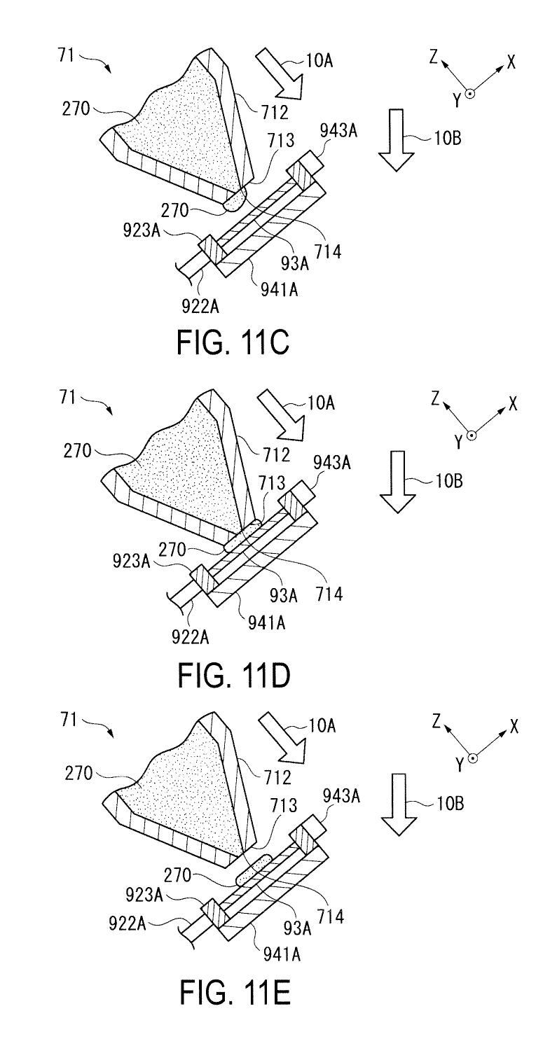

FIG. 10 is a flowchart showing the operation at the time of cleaning according to a modification of the second embodiment. FIG. 11A shows a state where the cleaning member does not face the nozzle. FIG. 11B shows a state where the cleaning member faces the nozzle with a predetermined gap therebetween. FIG. 11C shows a state where a predetermined amount of the target material is outputted through the nozzle. FIG. 11D shows a state where the cleaning member is in close proximity of the nozzle. FIG. 11E shows a state where the cleaning member faces the nozzle with a predetermined gap therebetween after the cleaning is completed.

In the modification of the second embodiment, the set output direction 10A may be inclined with respect to the gravitational direction 10B.

In the modification, after Step S1 through S3 of FIG. 10 are carried out, the target controller 80B may control the set pressure of the pressure adjuster 72 to a level at which a predetermined amount of the target material 270 is outputted through the nozzle 712 (Step S31). By causing a predetermined amount of the target material 270 to be outputted through nozzle, the target material 270 deposited around the nozzle opening 714 may be taken into a newly-outputted target material 270, which may cover the nozzle opening 714, as shown in FIG. 11C.

Thereafter, the target controller 80B may move the cleaning member 93A in the Z-direction so that the cleaning member 93A comes in close proximity of the tip 713, as shown in FIG. 11D (Step S32). Thus, the space between the tip 713 and the cleaning member 93A may be filled with the target material 270 that has been covering the nozzle opening 714. As a result, most of the target material 270 covering the nozzle opening 714 may adhere onto the cleaning member 93A which may have higher wettability with the target material 270 than the tip 713.

Then, the target controller 80B may carry out Steps S6 through S10 of FIG. 10.

In the second embodiment and the modification thereof, the driving mechanism 91A may move both the cleaning member 93A and the nozzle 712 or only the nozzle 712 to allow the cleaning member 93A and the nozzle 712 to be in close proximity of each other. Further, Step S7 may be omitted, and Step 8 may be carried out after Step S6. Further, the order of Steps S2 and S3 may be switched.

### 5.3 Third Embodiment

### 5.3.1 Configuration

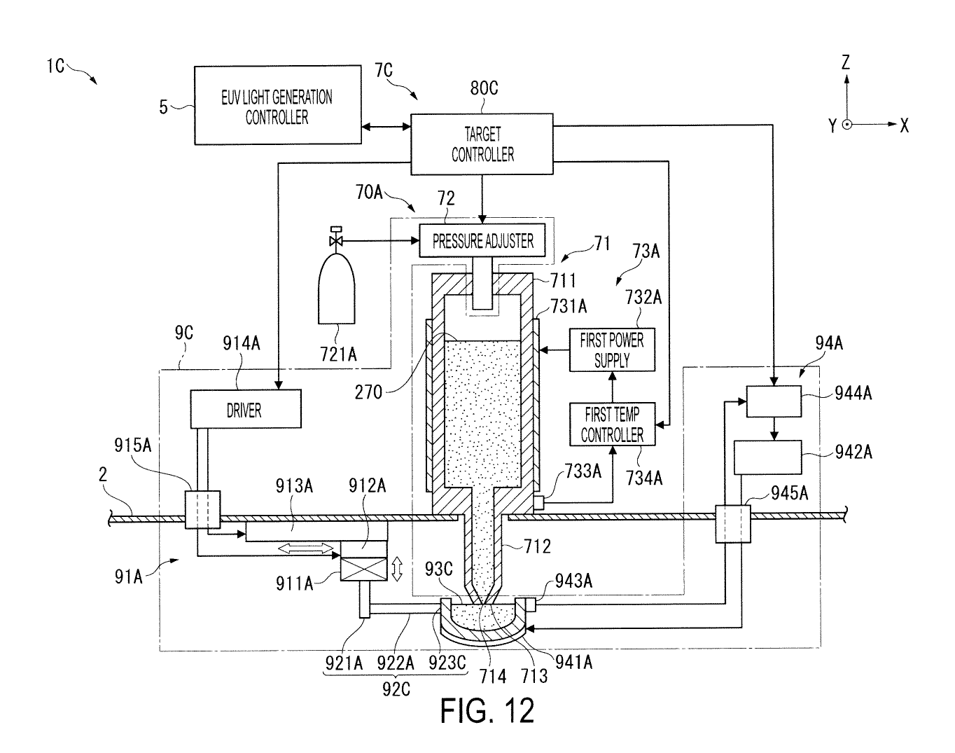

FIG. 12 schematically illustrates an example of the configuration of a part of an EUV light generation apparatus according to a third embodiment. An EUV light generation apparatus 1C may include the chamber 2, a target supply unit 7C, and a cleaning mechanism 9C. The target supply unit 7C may include the target generation unit 70A and a target controller 80C.

The cleaning mechanism 9C may include the driving mechanism 91A (close-proximity moving mechanism), a holding unit 92C, and the second temperature adjuster 94A. Further, the pressure adjuster 72 may be configured to function as an output controller constituting the cleaning mechanism 9C. The holding unit 92C may include the pole 921A, the insulating member 922A, and a container 923C. A liquid metal serving as a cleaning material 93C may be stored in the container 923C. The cleaning material 93C may be the same material as the target material 270.

### 5.3.2 Operation

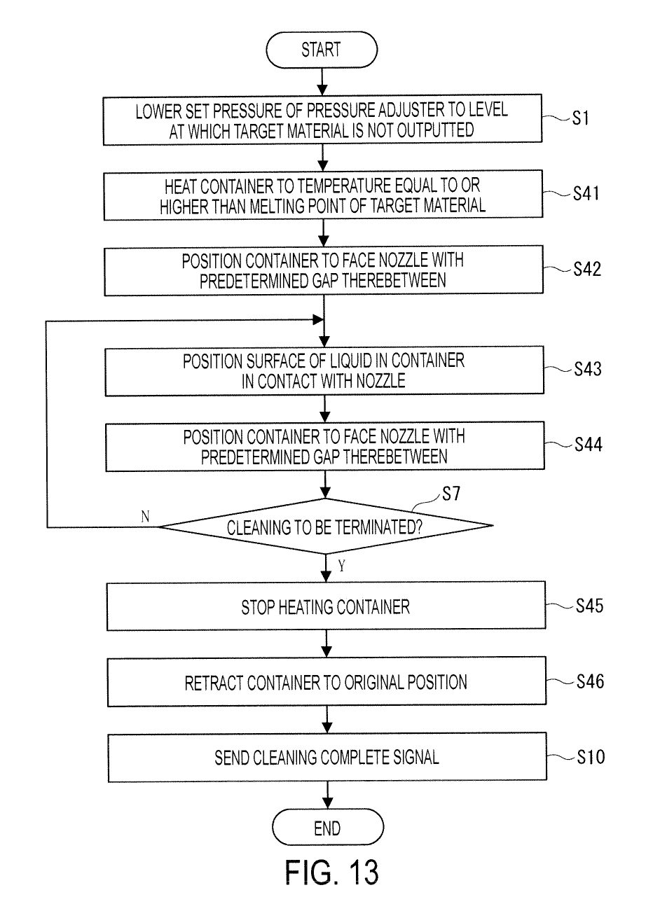

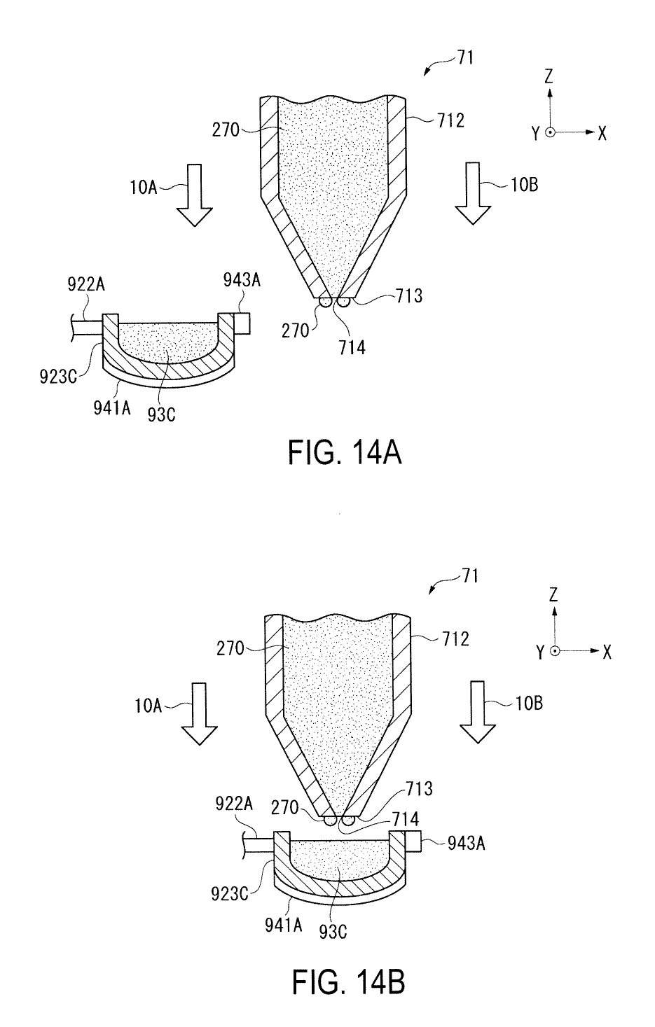

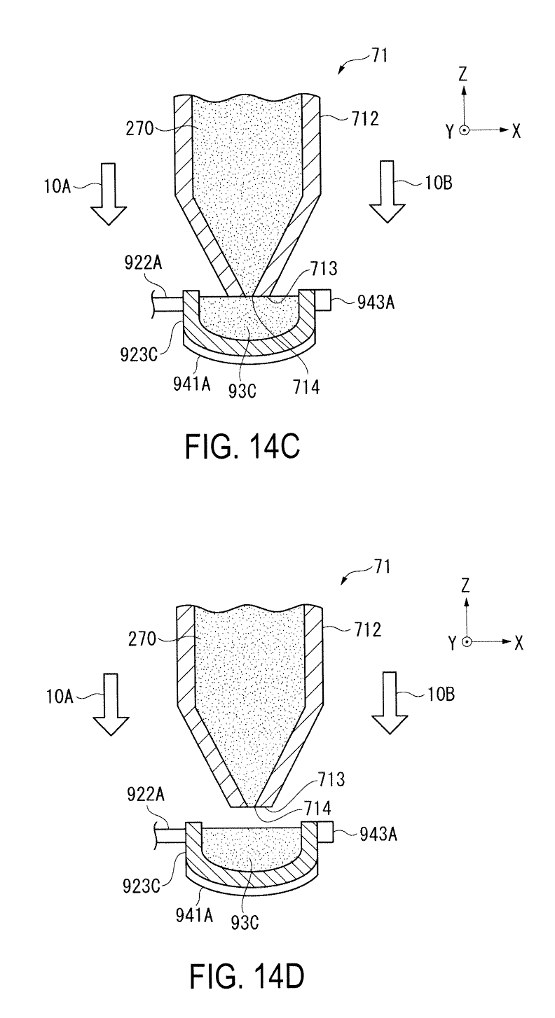

FIG. 13 is a flowchart showing the operation at the time of cleaning according to the third embodiment. FIG. 14A shows a state where the container does not face the nozzle according to the third embodiment. FIG. 14B shows a state where the container faces the nozzle with a predetermined gap therebetween according to the third embodiment. FIG. 14C shows a state where the cleaning material in the container is in contact with the nozzle according to the third embodiment. FIG. 14D shows a state where the container faces the nozzle with a predetermined gap therebetween after the cleaning is completed according to the third embodiment.

In the third embodiment of this disclosure, the case where the set output direction 10A coincides with the gravitational direction 10B will be illustrated.

Step S1 of FIG. 13 may first be carried out in the EUV light generation apparatus 1C. In Step S1, the container 923C may be positioned not to face the nozzle 712, as shown in FIG. 14A. At this point, the cleaning material 93C may be stored inside the container 923C in a solid state.

Then, the target controller 80C may send a signal to the second temperature controller 944A. Thus, the container 923C may be heated to a temperature that is equal to or higher than the melting point of the cleaning material 93C (Step S41). As the container 923C is heated, the temperature of the cleaning material 93C may reach or exceed the melting point thereof, whereby the cleaning material 93C may be molten. Thereafter, the target controller 80C may move the container 923C so as to face the tip 713 with a predetermined gap therebetween, as shown in FIG. 14B (Step S42).

Thereafter, the target controller 80C may move the container 923C in the Z-direction so that the surface of the cleaning material 93C in the container 923C comes into contact with the tip 713 of the nozzle 712, as shown in FIG. 14C (Step S43). As the cleaning material 93C makes contact with the tip 713, the target material 270 deposited around the nozzle opening 714 may be taken into the cleaning material 93C. Here, when the cleaning material 93C and the target material 270 are the same material, the target material 270 deposited around the nozzle opening 714 may be taken into the container 923C from the tip 713.

Then, the target controller 80C may move the container 923C away in the Z-direction from the nozzle 712 to position the container 923C to face the tip 713 with a predetermined gap therebetween, as shown in FIG. 14D (Step S44). By removing the container 923C away from the nozzle 712, the target material 270 deposited on the tip 713 may be removed from the tip 713.

Then, the target controller 80C may carry out Step S7 of FIG. 13. When the cleaning is not to be terminated (Step S7; NO), the target controller 80C may return to Step S43. On the other hand, when the cleaning is to be terminated (Step S7; YES), the heating of the container 923C may be stopped (Step S45).

Thereafter, the target controller 80C may retract the container 923C to a position shown, for example, in FIG. 14A (Step S46). Then, the target controller 80C may send a cleaning complete signal to the EUV light generation controller 5 (Step S10) so that the cleaning may be terminated.

With the above-noted configuration and operation, the target material 270 deposited on the nozzle 712 may be removed physically from the nozzle 712, and the nozzle 712 may be cleaned. Not only when the set output direction 10A coincides with the gravitational direction 10B, but also when the set output direction 10A is inclined with respect to the gravitational direction 10B, the target material 270 deposited on the nozzle 712 may be taken into the cleaning material 93C in the container 923C.

Further, since the nozzle 712 makes contact with the surface of the cleaning material 93C, instead of a solid material, the damage to the nozzle 712 may be suppressed.

Here, the driving mechanism 91A may move both the container 923C and the nozzle 712 or only the nozzle 712 to allow the cleaning material 93C and the nozzle 712 to come into contact with each other. Further, Step S7 may be omitted, and Step 45 may be carried out after Step S44. Furthermore, for the liquid metal serving as the cleaning material 93C, a material that differs from the target material 270 may be used. However, when a material that is the same as the target material 270 is used as the cleaning material 93C, a reactant of the cleaning material 93C and the target material 270 may be prevented from being generated, whereby the reactant may be prevented from accumulating in the container 923C.

### 5.4 Fourth Embodiment

### 5.4.1 Configuration

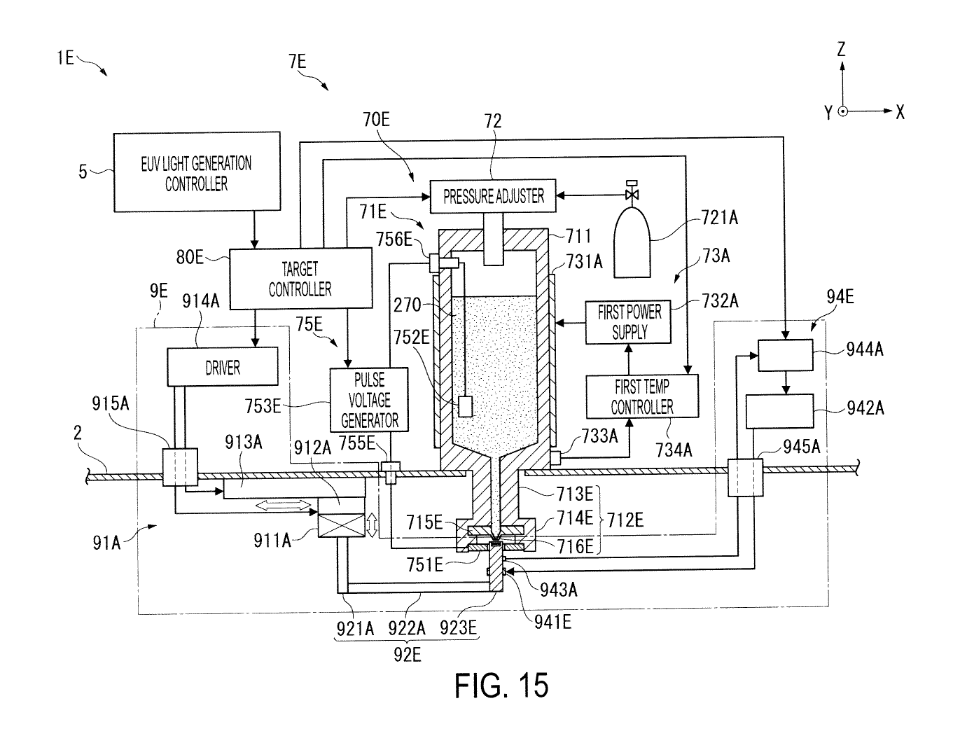

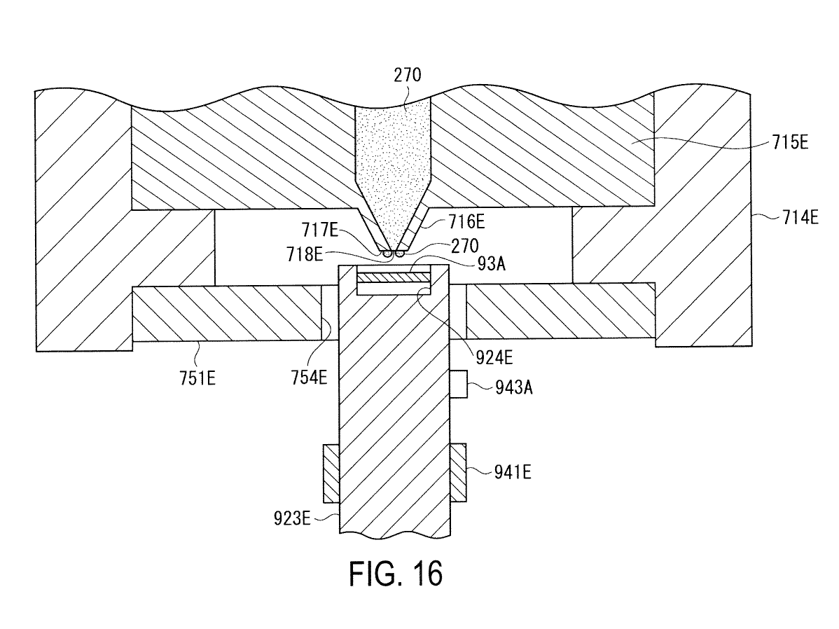

FIG. 15 schematically illustrates an example of the configuration of a part of an EUV light generation apparatus according to a fourth embodiment. FIG. 16 is an enlarged view of the primary components of the EUV light generation apparatus according to the fourth embodiment. An EUV light generation apparatus 1E may include the chamber 2, a target supply unit 7E, and a cleaning mechanism 9E. The target supply unit 7E may include a target generation unit 70E and a target controller 80E. The target generation unit 70E may include a target generator 71E, the pressure adjuster 72, the first temperature adjuster 73A, and an electrostatic pull-out unit 75E.

The target generator 71E may include the tank 711 and a nozzle 712E. The nozzle 712E may include a nozzle body 713E, a holding unit 714E, and an output unit 715E. The nozzle body 713E may be provided so as to project into the chamber 2 from the bottom surface of the tank 711. The holding unit 714E may be provided at the leading end of the nozzle body 713E. The holding unit 714E may be formed cylindrically with a diameter larger than the diameter of the nozzle body 713E. The holding unit 714E may be formed separately from the nozzle body 713E and be fixed to the nozzle body 713E.

The output unit 715E may be substantially disc-shaped. The output unit 715E may be held by the holding unit 714E so as to be in contact with the leading end surface of the nozzle body 713E. A frustoconical protrusion 716E may be formed at the center of the output unit 715E. The protrusion 716E may be provided so that the electric field is likely to be enhanced at the protrusion 716E. Referring to FIG. 16, the protrusion 716E may have a nozzle opening 718E formed at substantially the center of an upper end 717E of the frustoconical protrusion 716E. The output unit 715E may preferably be formed of a material having low wettability with the target material 270. When the output unit 715E is not formed of a material having low wettability with the target material 270, the output unit 715E may preferably be coated with a material having low wettability with the target material 270 on at least the surface thereof.

Each of the tank 711, the nozzle 712E, and the output unit 715E may be formed of an electrically non-conductive material. When the above-noted components are not formed of an electrically non-conductive material (e.g., when the above-noted components are formed of a metal material, such as molybdenum), an electrically non-conductive material may be provided between the chamber 2 and the target generator 71E, and between the output unit 715E and a pull-out electrode 751E which will be described later. In this case, the tank 711 may be electrically connected to a pulse voltage generator 753E which will be described later.

The electrostatic pull-out unit 75E may include the pull-out electrode 751E, an electrode 752E, and the pulse voltage generator 753E. Referring to FIG. 16, the pull-out electrode 751E may be substantially disc-shaped. The pull-out electrode 751E may have a circular through-hole 754E formed at the center thereof. The pull-out electrode 751E may be held by the holding unit 714E with a space formed between the pull-out electrode 751E and the output unit 715E. The pull-out electrode 751E may preferably be held such that the rotational axis of the frustoconical protrusion 716E passes through the center of the through-hole 754E. The pull-out electrode 751E may be connected to the pulse voltage generator 753E through a fourth introduction terminal 755E.

The electrode 752E may be provided inside the tank 711 and in contact with the target material 270. The electrode 752E may be connected to the pulse voltage generator 753E through a feedthrough 756E. The pulse voltage generator 753E may be connected to the target controller 80E. The pulse voltage generator 753E may be configured to apply a voltage between the electrode 752E and the pull-out electrode 751E. Thus, the target material 270 may be pulled out in the form of droplets due to the electrostatic force.

The cleaning mechanism 9E may include the driving mechanism 91A, a holding unit 92E, the cleaning member 93A (see FIG. 16), and a second temperature adjuster 94E. The holding unit 92E may include the pole 921A, the insulating member 922A, and a holder 923E. Referring to FIG. 16, the holder 923E may be formed of a thermally conductive material. The holder 923E may be substantially columnar having a diameter smaller than the inner diameter of the through-hole 754E. A recess 924E may be formed at the end surface of the holder 923E. The recess 924E may be circular in shape having a diameter larger than the outer diameter of the upper end 717E of the protrusion 716E. Alternatively, the recess 924E need not be circular in shape as long as it is larger than the outer diameter of the upper end 717E. The cleaning member 93A may be provided in the recess 924E so as to cover the bottom surface of the recess 924E. The cleaning member 93A may preferably be formed of a material having higher wettability with the target material 270 than at least the upper end 717E of the protrusion 716E. The cleaning member 93A may be circular in shape having a diameter larger than the outer diameter of the upper end 717E. Thus, the target material 270 deposited around the nozzle opening 718E may adhere onto the cleaning member 93A when the cleaning member 93A makes contact with the upper end 717E. Alternatively, the cleaning member 93A need not be circular in shape as long as it is larger than the outer diameter of the upper end 717E.

Referring to FIG. 16, without providing the cleaning member 93A in the recess 924E, the recess 924E in the holder 923E may be used as a container in which a cleaning material is stored. Here, the holder 923E may be configured to allow the cleaning member 93A to make contact with the upper end 717E without coming into contact with the pull-out electrode 751E.

Referring to FIG. 15, the second temperature adjuster 94E may include a second heater 941E, the second heater power supply 942A, the second temperature sensor 943A, the second temperature controller 944A, and the second introduction terminal 945A. The second heater 941E may be provided so as to cover a part of the outer surface of the holder 923E (see FIG. 16). The second temperature sensor 943A may be provided on the outer surface of the holder 923E.

### 5.4.2 Operation

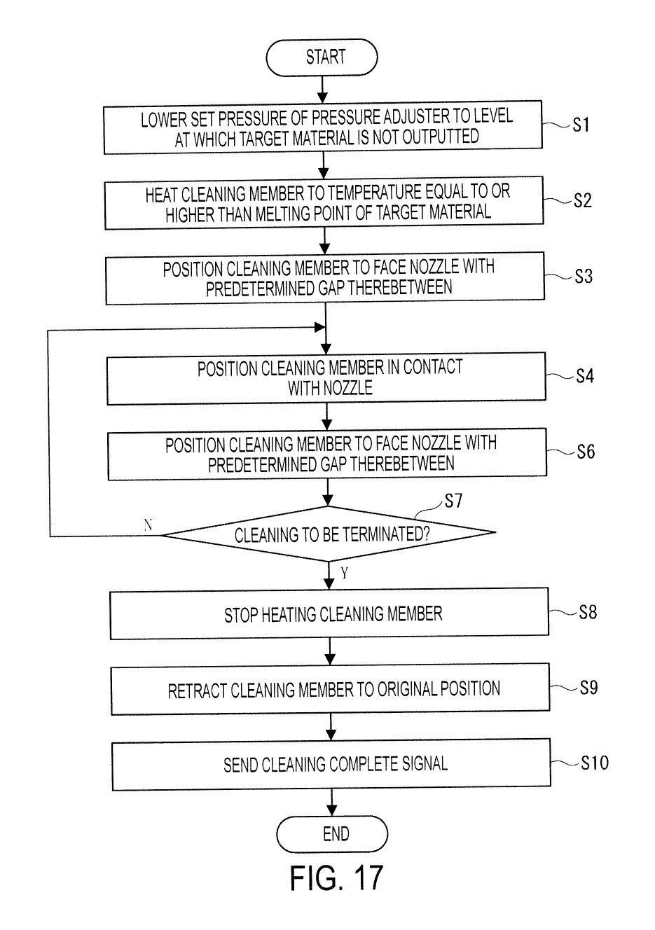

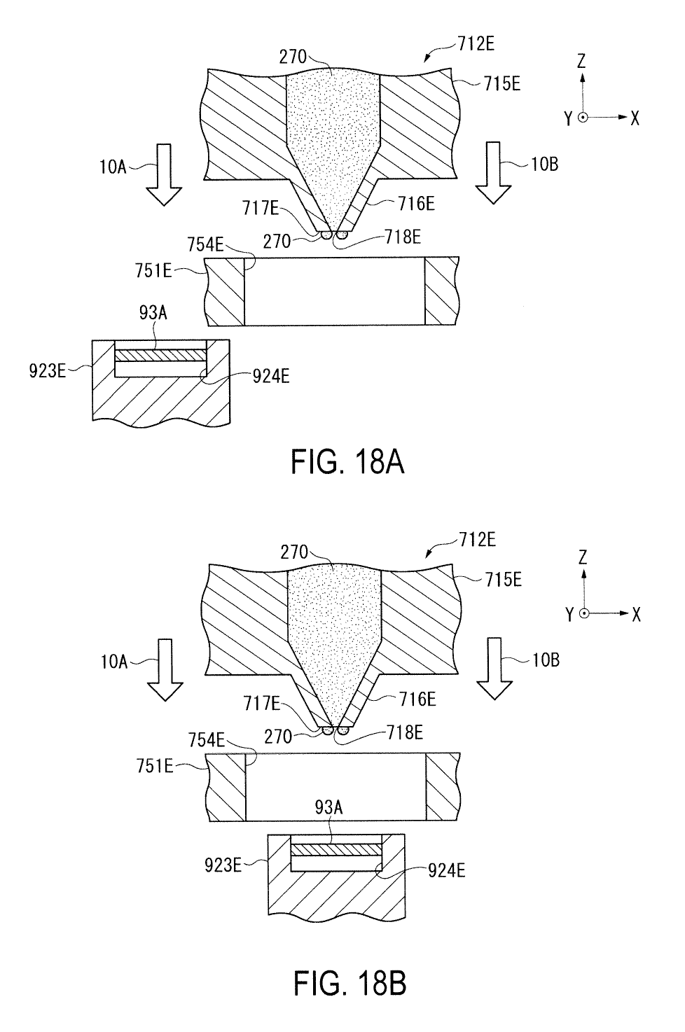

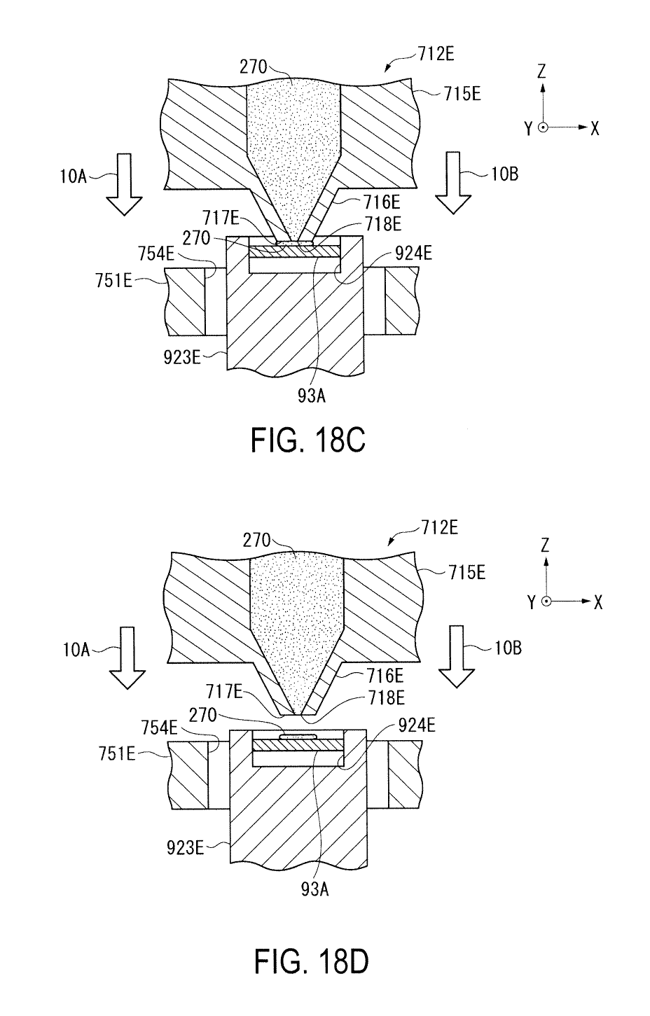

FIG. 17 is a flowchart showing the operation at the time of cleaning according to the fourth embodiment. FIG. 18A shows a state where the cleaning member 93A does not face the nozzle 712E according to the fourth embodiment. FIG. 18B shows a state where the cleaning member 93A faces the nozzle 712E with a predetermined gap therebetween according to the fourth embodiment. FIG. 18C shows a state where the cleaning member 93A is in contact with the nozzle 712E according to the fourth embodiment. FIG. 18D shows a state where the cleaning member 93A faces the nozzle 712E with a predetermined gap therebetween after the cleaning is completed according to the fourth embodiment.

Steps S1 through S4 of FIG. 17 may first be carried out in the EUV light generation apparatus 1E. Steps S1 through S4 may be similar to those of the first embodiment. In Steps S1 and S2, the cleaning member 93A may be positioned not to face the nozzle 712E, as shown in FIG. 18A.

In Step 3, the target controller 80E may move the cleaning member 93A so that the cleaning member 93A faces the upper end 717E with a predetermined gap therebetween, as shown in FIG. 18B. Here, the target controller 80E may control the cleaning mechanism 9E such that the rotational axis of the holder 923E passes through the center of the through-hole 754E.

Thereafter, the target controller 80E may position the cleaning member 93A in contact with the upper end 717E, as shown in FIG. 18C (Step 4). Here, the target controller 80E may control the cleaning mechanism 9E such that the holder 923E passes through the through-hole 754E. In this way, as the cleaning member 93A makes contact with the upper end 717E, the target material 270 deposited around the nozzle opening 718E may adhere onto the cleaning member 93A.

Thereafter, the target controller 80E may move the holder 923E in the Z-direction away from the upper end 717E to thereby position the cleaning member 93A to face the upper end 717E with a predetermined gap therebetween, as shown in FIG. 18D (Step 6). The distance between the cleaning member 93A and the upper end 717E at this point may be the same as or different from that of the state shown in FIG. 18B. By removing the cleaning member 93A away from the upper end 717E, most of the target material 270 deposited on the upper end 717E may adhere onto the cleaning member 93A, whereby the target material 270 may be removed from the upper end 717E. Thereafter, Steps S7 through S10 may be carried out in the EUV light generation apparatus 1E. Steps S7 through S10 may be similar to those of the first embodiment.

As described above, even with the so-called electrostatic pull-out type target supply unit 7E, the cleaning mechanism 9E may clean the nozzle 712E by positioning the cleaning member 93A in contact with the nozzle 712E without opening the chamber 2.

Here, when the cleaning member 93A is moved back and forth in the X-direction after making contact with the upper end 717E, the cleaning performance may be improved. However, the nozzle opening 718E may be deformed when the cleaning member 93A is moved back and forth in the X-direction while being in contact with the upper end 717E. On the contrary, when the cleaning is carried out by moving the cleaning member 93A only in the Z-direction, the force in the X-direction may be prevented from acting on the protrusion 716E, whereby the damage to the protrusion 716E may be suppressed.

Here, the cleaning method in the second or third embodiment may be adopted. Then, the force that acts on the protrusion 716E may be made even smaller.

### 5.5 Fifth Embodiment

### 5.5.1 Configuration

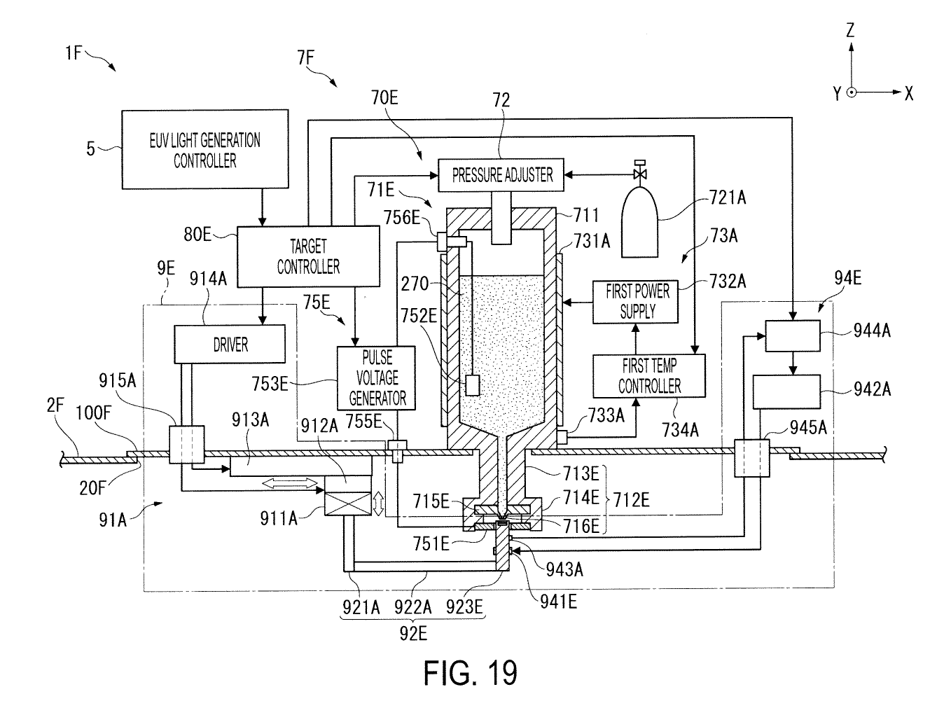

FIG. 19 schematically illustrates an example of the configuration of a part of an EUV light generation apparatus according to a fifth embodiment. An EUV light generation apparatus 1F may include a chamber 2F, and a target supply unit 7F. The chamber 2F may have an opening 20F formed in the wall thereof, the opening 20F being sized to be sealable by a plate 100F. The target supply unit 7F may include the target generation unit 70E, the target controller 80E, the cleaning mechanism 9E, and the plate 100F.

The target generator 71E may be mounted onto the plate 100F such that the nozzle 712E penetrates the plate 100F and the tank 711 is arranged on one surface of the plate 100F. An airtight sealing unit (not shown) may be provided between the plate 100F and the target generator 71E at the connection part thereof. The driving mechanism 91A of the cleaning mechanism 9E may be arranged on the other surface of the plate 100F. The first introduction terminal 915A, the second introduction terminal 945A, and the fourth introduction terminal 755E may be provided in the plate 100F so as to penetrate the plate 100F. The plate 100F, on which the target generator 71E and the cleaning mechanism 9E are provided, may be fixed on the chamber 2F so as to seal the opening 20F. An airtight sealing unit (not shown) may be provided between the plate 100F and the opening 20F so as to seal the chamber 2F.

The target supply unit 7F configured as such may function similarly to the target supply unit 7E of the fourth embodiment. Since the target generator 71E and the cleaning mechanism 9E are integrated by the plate 100F, the positioning of the cleaning mechanism 9E with respect to the target generator 71E or the operation check of the cleaning mechanism 9E may be carried out in a state where the target generator 71E is not mounted on the chamber 2F (e.g., when the target generator 71E is placed on an adjusting stand (not shown)). Further, the maintenance work may be carried out on the cleaning mechanism 9F or the cleaning mechanism 9F may be replaced when the maintenance work is carried out on the target generator 71E or when the target generator 71E is replaced.

In the fifth embodiment, the set output direction 10A may coincide with the gravitational direction 10B. The operation at the time of cleaning according to the fifth embodiment may similar to that of the fourth embodiment, and thus, detailed description thereof will be omitted.

5.6 Variation of Target supply Unit

### 5.6.1 Configuration

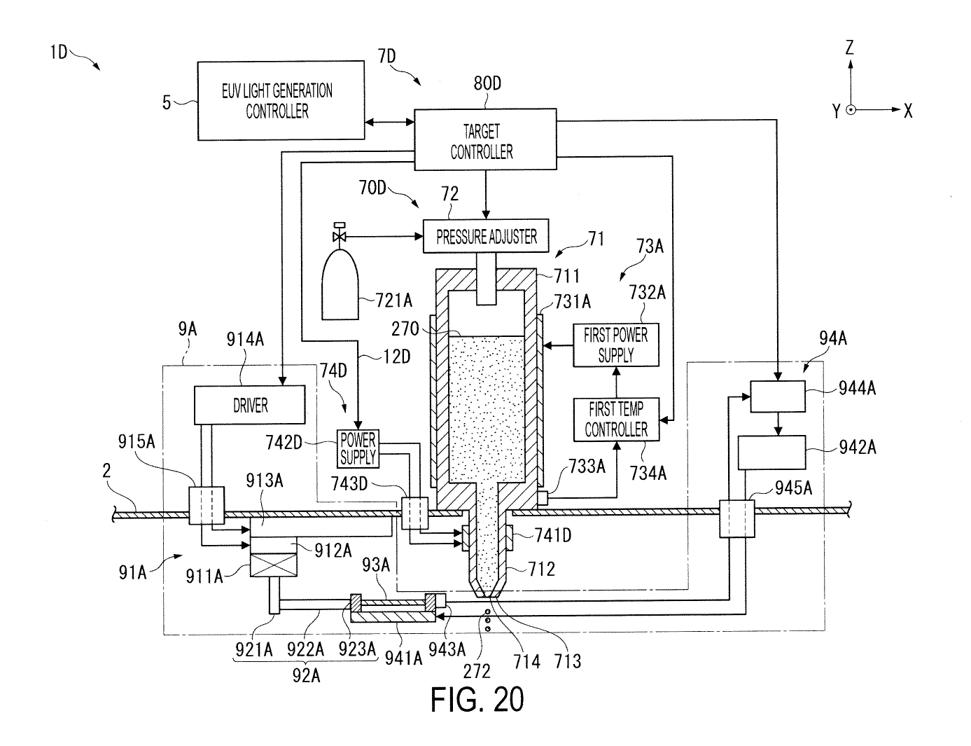

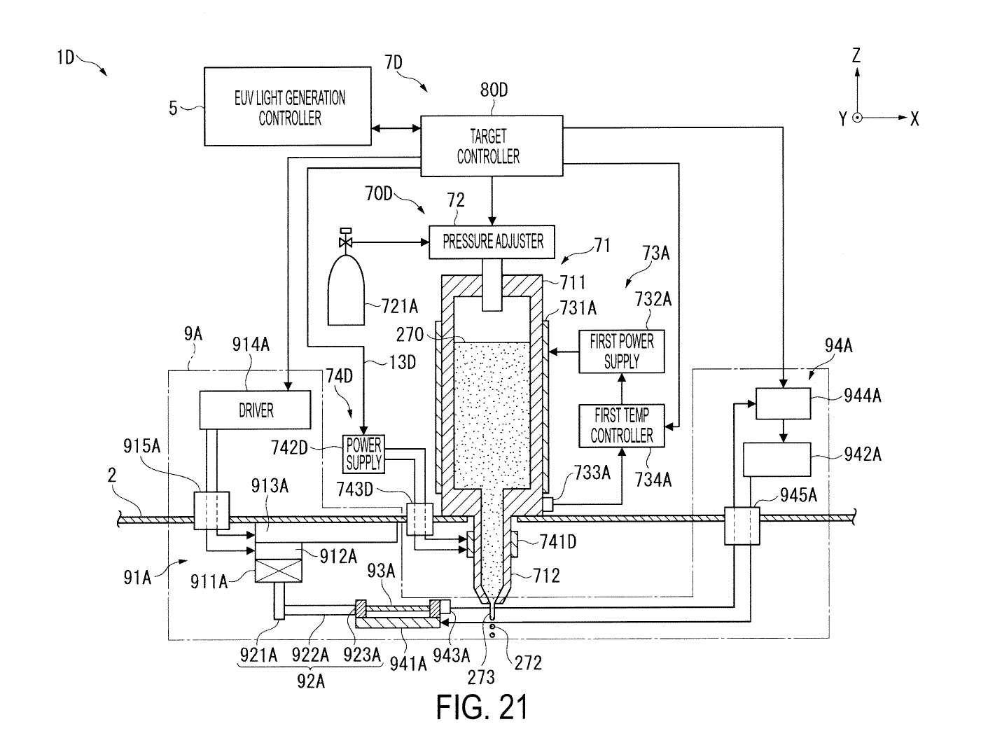

FIG. 20 schematically illustrates an example of the configuration of a target supply unit configured to generate droplets on-demand. FIG. 21 schematically illustrates an example of the configuration of a target supply unit configured to generate droplets from a continuous jet.

An EUV light generation apparatus 1D may include the chamber 2, a target supply unit 7D, and the cleaning mechanism 9A. A target generation unit 70D of the target supply unit 7D may include the target generator 71, the pressure adjuster 72, the first temperature adjuster 73A, and a piezoelectric element push-out unit 74D. The piezoelectric element push-out unit 74D may include a piezoelectric element 741D and a piezoelectric element power supply 742D. The piezoelectric element 741D may be provided on the outer surface of the nozzle 712. In place of the piezoelectric element 741D, a mechanism capable of applying force to the nozzle 712 at high speed may be provided. The piezoelectric element power supply 742D may be connected to the piezoelectric element 741D through a third introduction terminal 743D provided in the wall of the chamber 2. The piezoelectric element power supply 742D may be connected to a target controller 80D.

### 5.6.2 Operation

The target controller 80D may first send a signal to the pressure adjuster 72 to adjust the pressure inside the tank 711 to a predetermined pressure. The predetermined pressure may be a pressure at which a meniscus of the target material 270 is formed at the nozzle opening 714. In this state, droplets 272 may not be outputted.

Then, with reference to FIG. 20, the target controller 80D may send a droplet generation signal 12D to the piezoelectric element power supply 742D to cause the droplets 272 to be generated on-demand. Upon receiving the droplet generation signal 12D, the piezoelectric element power supply 742D may supply predetermined pulsed power to the piezoelectric element 741D. Thus, the piezoelectric element 741D may deform in accordance with the supplied pulsed power. In this way, the nozzle 712 may be pressurized at high speed, and the droplets 272 may be outputted through the nozzle 712. When the pressure inside the tank 711 is retained at the predetermined pressure, the droplets 272 may be outputted in accordance with the supply timing of the power.

Alternatively, with reference to FIG. 21, the target controller 80D may be configured to adjust the pressure inside the tank 711 such that a jet 273 of the target material 270 is generated. The pressure inside the tank 711 at this time may be higher than the aforementioned predetermined pressure. Then, the target controller 80D may be configured to send a vibration signal 13D to the piezoelectric element power supply 742D to generate the droplets 272. Upon receiving the vibration signal 13D, the piezoelectric element power supply 742D may supply power to the piezoelectric element 741D to case the piezoelectric element 741D to vibrate. Thus, the piezoelectric element 741D may cause the nozzle 712 to vibrate at high speed. In this way, the jet 273 may be divided at a constant cycle, whereby the droplets 272 as the divided jet 273 may be generated.

The above-described embodiments and the modifications thereof are merely examples for implementing this disclosure, and this disclosure is not limited thereto. Making various modifications according to the specifications or the like is within the scope of this disclosure, and other various embodiments are possible within the scope of this disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as at least one or “one or more.”

What is claimed is:

1. An apparatus for physically cleaning a nozzle inside a chamber, the nozzle being configured to output a target material into the chamber in which extreme ultraviolet light is generated, the apparatus comprising:
a cleaning member disposed inside the chamber and configured to remove the target material deposited around the nozzle.

2. The apparatus according to claim 1, further comprising:
a temperature adjuster configured to adjust a temperature of the cleaning member to a temperature equal to or higher than the melting point of the target material; and
a contact moving driver configured to move the cleaning member with respect to the nozzle such that the cleaning member is movable to come into contact with the nozzle,
wherein a contact angle between the cleaning member and the target material is smaller than a contact angle between the nozzle and the target material.

3. The apparatus according to claim 1, further comprising:
a temperature adjuster configured to adjust a temperature of the cleaning member to a temperature equal to or higher than the melting point of the target material;
a close-proximity moving driver configured to move the cleaning member with respect to the nozzle such that the cleaning member is movable to come into close proximity of the nozzle; and
an output controller configured to cause the target material to be outputted through the nozzle,
wherein a contact angle between the cleaning member and the target material is smaller than a contact angle between the nozzle and the target material.

4. The apparatus according to claim 1, further comprising:
a container for storing a cleaning material; and
a contact moving driver configured to move the container with respect to the nozzle such that the cleaning material is movable to come into contact with the nozzle.

5. The apparatus according to claim 1, further comprising:
a container for storing a cleaning material containing the target material;
a temperature adjuster for adjusting a temperature of the cleaning material stored in the container to a temperature equal to or higher than the melting point of the cleaning material; and
a contact moving driver configured to move the cleaning member with respect to the nozzle such that the cleaning member is movable to come into contact with the nozzle.

6. A target supply apparatus, comprising
a nozzle through which a target material is outputted into a chamber in which extreme ultraviolet light is generated;
the apparatus for physically cleaning the nozzle inside the chamber according to claim 1; and
an integrator for integrating the nozzle and the apparatus.

7. A method for physically cleaning a nozzle inside a chamber, the nozzle being configured to output a target material into the chamber in which extreme ultraviolet light is generated, the method comprising:
physically cleaning the nozzle in the chamber that is retained at a pressure lower than the atmospheric pressure.

8. The method according to claim 7, further comprising:
adjusting a temperature of the cleaning member to a temperature equal to or higher than the melting point of the target material;
causing the cleaning member and the nozzle to come into contact with each other; and
controlling the cleaning member and the nozzle to move away from each other.

9. The method according to claim 7, further comprising:
adjusting a temperature of the cleaning member to a temperature equal to or higher than the melting point of the target material;
causing the cleaning member and the nozzle to come in close proximity of each other;
causing a predetermined amount of the target material to be outputted through the nozzle; and
controlling the cleaning member and the nozzle to move away from each other.

10. The method according to claim 7, further comprising:
adjusting a temperature of the cleaning member to a temperature equal to or higher than the melting point of the target material;
causing a predetermined amount of the target material to be outputted through the nozzle;
causing the cleaning member and the nozzle to come in close proximity of each other; and
controlling the cleaning member and the nozzle to move away from each other.

11. The method according to claim 7, further comprising:
causing a cleaning material in a container and the nozzle to come into contact with each other; and
controlling the container and the nozzle to move away from each other.

12. The method according to claim 7, further comprising:
adjusting a temperature of a cleaning material containing the target material in a container to a temperature equal to or higher than the melting point of the cleaning material;
causing the cleaning material in the container and the nozzle to come into contact with each other; and
controlling the container and the nozzle to move away from each other.
